(19) United States
(12) Patent Application Publication
(10) Pub. No.: US 2003/0061096 A1
(43) Pub. Date: Mar. 27, 2003

(54) System and method for use for linking primary market research data with secondary research data

(76) Inventors: Gerald J. Gallivan, Naples, FL (US); Timothy A. Margraf, Medford, NJ (US); Lorie M. Preston, Newtown, PA (US); Gerhard K. Gallwitz, Haddonfield, NJ (US)

Correspondence Address: CAESAR, RIVISE, BERNSTEIN,, COHEN & POKOTILOW, LTD., 12TH FLOOR, SEVEN PENN CENTER, 1635 MARKET STREET, PHILADELPHIA, PA, 19103-2212, US

(21) Appl. No.: 10/142,028

(22) Filed: May 9, 2002

Related U.S. Application Data
(63) Continuation-in-part of application No. 09/947,034, filed on Sep. 5, 2001.

(51) Int. Cl. G06F 17/60

(52) U.S. Cl. 705/14; 705/2

(57) ABSTRACT

A computerized system and method for conducting a survey of the promotional activities of sales representatives for specific pharmaceuticals of the various pharmaceutical companies. A single panel of physicians is provided to collect data regarding both (1) the promotional activities of the sales representatives whom they have encountered, and (2) the diagnosis and treatment of their patients. The data is provided into a database for analysis to evaluate any cause and effect relationship between the promotional activities of the sales representatives and the pharmaceuticals prescribed by them to their patients. Primary market research studies can also be conducted by select appropriate physicians from the panel to whom a survey is to be administered and by analyzing their answers in the context of the data in the database.

### RELATED APPLICATION

This application is a Continuation-In-Part of U.S. patent application Ser. No. 09/947,034, filed on Sep. 5, 2001, entitled Computerized Pharmaceutical Sales Representative Performance Analysis System And Method Of Use which is assigned to the same assignee as this invention, and whose disclosure is incorporated by reference herein.

### BACKGROUND OF THE INVENTION

This invention relates generally to analysis systems and more particularly to systems for analyzing the performance of pharmaceutical sales representatives.

Pharmaceutical companies market their products to physicians via in-house sales representatives or external sales organizations. In either case the sales representative, sometimes referred to as the “rep” or “detail” person, seeks to gain access to the physician to influence the treatment decision in favor of that rep's pharmaceutical company's drugs. Pharmaceutical companies devote a considerable amount of time to determining the effectiveness of their sales reps. This involves the collection and analysis of market research data regarding visits to dispensing physicians, et cetera. Many pharmaceutical companies conduct such market research activities in-house, while many also make use of outside, “data survey” providers to collect and analyze that information. Examples, of such outside firms are IMS Health, Inc. of Plymouth Meeting, Pa., Scott-Levin (a division of Quintiles Transnational, Inc.) of Newton, Pa. and Health Products Research (a division of Ventiv Health, Inc.) Of New York, N.Y. These data survey provider companies typically provide data collection and analysis services to the pharmaceutical industry on either a syndicated or a customized consulting basis. By syndicated it is meant that the companies collecting and analyzing the data regarding the promotional activities of the sales reps do so on an industry-wide basis and provide that information to any pharmaceutical manufacturer engaging their services.

The market research data collected heretofore has comprised data in the form of disease and treatment information and promotion activity information. In particular, the prior art typically recruits two panels of physicians across multi-disciplines to collect the data they require. There may be approximately 3500 or more physicians in each panel, with separate physician panels for the promotion data and the disease and treatment data. The audit of the physicians panels which has been accomplished in the past has been achieved by two types of methodologies. IMS Health, for example, has a panel of approximately 3,500 physicians, who are asked to provide information regarding the promotional activity of all of the reps that they meet every day. Scott Levin, on the other hand, uses a larger number of physicians for its panel, e.g., 7,000, however, collect less information from each physician than IMS Health. These physicians are asked to collect and record the promotional activity data one week a month. This information is recorded by the physicians of the panels on hard copy forms, sometimes called “diaries.” Among the promotional activity information that both companies have their panel of physicians collect is the company name, what products were “detailed,” the rating of the detail, the quality of the sales rep, e.g., poor, good, fair, et cetera, what product messages were provided by the representative, was the product compared to another product, safety, efficacy, et cetera. No data is collected regarding any tailored messages that the rep has been instructed to convey to the physician. In this regard, it is a common practice for pharmaceutical companies to have their reps deliver a specific or tailored message about each of their drugs to dispensing physicians, e.g., that this particular drug reduces fractures. This message is desired to be conveyed to the physician so that he/she will think of that concept when dealing with his/her patients who may need a drug for a specific treatment. In this example, the message about a specific drug reducing fractures would be one that a pharmaceutical company would want its reps to deliver to physicians who have a practice including many elderly persons. The prior art data collection does not collect information as to whether this tailored message was delivered to the physician, but rather collects generic information about the drugs, such as safety, efficacy, patient tolerance to the drug, etc.

A few of the survey provider companies also collect pharmacy-based data, that is data purchased from national pharmacy chains, regarding what drugs were dispensed. They integrate this data into their reports and attempt to determine cause and effect with the pharmacy generated data and the promotional data in the attempt to discern that a certain amount of promotional activity resulted in a certain amount of dispensed pharmaceuticals.

The prior art data survey companies use the filled-in paper forms received from their panels of physicians to enter that data manually into their databases and then to process that data for quality assurance and quality control. The data is compiled, analyzed and delivered to the pharmaceutical companies either in hard copy or electronically. For example, the hard copy may be in the form of monthly books, e.g., the “May 2001 Promotional Activities Information” and the “May 2001 Disease and Treatment Activities.” Among the information provided in these books or electronically are information regarding the various pharmaceutical companies, the various drugs of those companies, the number of times a sales representative or sales company has detailed the product to the physicians, et cetera. This information is broken out overtime, with trends being indicated. The information is also broken out specially by company so that users of the report can compare company to company or product to product.

The prior art data survey providers also makes available to their pharmaceutical company clients data access tools that can be used with the electronically provided data to enable their clients to pick and choose the specific information that they want to see. For example, one typical query using such a data access tool would be to ask the system to compare one osteoarthritis drug against another osteoarthritis drug. These two drugs can then be analyzed with respect to each other with respect to market share, detailing level, promotional activities, counts, dollars, etc. Thus, the pharmaceutical company clients of the prior art data survey providers are able to get information about what their particular competitors are doing with respect to the detailing of the competing products. The pharmaceutical companies use this information to see if they can get a competitive advantage over their competitors.

Irrespective of which data survey provider company provides the data collection and analysis services, the physicians within their two panels do not cross over and provide information regarding the activities of the other panel. Thus, the physicians on the promotional panel do not provide any data regarding the diagnosis and treatment of their patient, they only collect and report data relating to the promotional activities of the reps who visit them. Conversely, the physicians on the disease and treatment panel do not provide any data regarding the promotional activities of the reps who visit them, they only collect and report on the diagnosis and treatment of their patients.

Since the data is provided with respect to either promotional activities or disease and treatment and are generated from two, separate and distinct, physician panels, which don't interact, the reports generated by the prior art are inherently incapable of drawing any accurate conclusions as to any correlation or causal link between the promotional activities of the reps and treatment of the patient, e.g., drugs prescribed. Collecting data regarding the drugs actually dispensed by the national pharmacy chains doesn't provide any meaningful insight into that causal link, since the drugs actually dispensed may not be the drugs prescribed by the physicians, e.g., a generic drug may be substituted, an insurance company may have required the substitution of one drug for another, etc. Thus, the prior art attempts to accurately link the pharmacy generated data with the promotional data to try to determine that a certain amount of promotional activity resulted in a certain amount of pharmaceuticals prescribed is doomed to failure.

Another drawback of the prior art data survey techniques for the pharmaceutical industry, is that heretofore no one has collected any information regarding the actual access of the reps to the physicians. Pharmaceutical companies collect data from their own reps themselves, as to the visits by the reps, but such data is not sufficiently specific as to whether or not the rep actually got past the front desk of the physician's office to speak to the physician. In this regard, most reps for the pharmaceutical companies are required to fill out sales call reports on their sales force automation tools. The pharmaceutical companies use this information in their analysis of the effectiveness of their promotional activities. However, these “call reports” are for the specific company for whom the rep works, and not for the industry as a whole. Thus, since the prior art companies providing the reports to the pharmaceutical companies do not collect access information, the only access information a pharmaceutical company will have will be the access information for its own reps, and not for those of its competitors.

As is known, many pharmaceutical companies have several companies or sales organizations represent them detailing the pharmaceutical company's products. In the past, the data gathered by the prior art was company-wide and not broken down by the specific representation groups doing the detailing. In short, the audits provided by the prior art do not capture any subset sales force activity, e.g., activity by various sales organizations representing a single pharmaceutical manufacturer. Heretofore this information has never been provided to pharmaceutical companies in a syndicated product. Data of this type might be provided by consultants to the pharmaceutical company's in the process of doing a personalized audit for such companies. However, even such customized audits are not industry-wide.

When pharmaceutical companies conduct or have conducted for them primary market research studies for a particular topic of interest the results may be inaccurate or skewed as a result of the physicians recruited for the study. In this regard, many of these studies are conducted of physicians, by asking them specifically designed or tailored questions. Heretofore such questions have been directed to those physicians which the researcher infers are appropriate to provide the answers sought, e.g., physicians who are deemed to have a certain attribute based on data collected from pharmacy sources and/or sales representatives or other secondary sources. However, as set forth in detail above, the prior art data collection techniques are insufficient to accurately determine the actual attributes of the physicians, e.g., the amount and quality of promotion provided to the physicians and their actual treatment/prescription tendencies. Rather their attributes are inferred from the secondary data collected. Thus, the prior art is not capable of conducting accurate primary market research to determine the attitudes, beliefs and opinions of the physicians with respect to the products, e.g., drugs, being promoted to them.

### SUMMARY OF THE INVENTION

This invention relates to a system and method for collecting information for the pharmaceutical industry to evaluate the attitudes, beliefs and opinions of physicians regarding specific pharmaceuticals. The method entails establishing a single panel of a plurality of geographically diversified prescribing physicians. Promotional activity data is collected from each of the physicians regarding the promotional activities of the sales representatives with respect to the physicians and to specific pharmaceuticals to determine the promotional exposure to the physicians. Treatment data is collected from each of the physicians regarding the diagnosis and treatment of their patients with respect to the specific pharmaceuticals to determine the treatment patterns of the physicians. The promotional activity data and the treatment data is used to establish the known history of promotional exposure to the physicians and the known patient treatment patterns of the physicians. Attitude, belief and opinion data is collected from at least selected ones of the physicians regarding their attitudes, beliefs and opinions with respect to the specific pharmaceuticals.

In accordance with one exemplary aspect of this invention the attitude and opinion data is analyzed regarding the attitudes, beliefs and opinions of the physicians based on their known history of promotional exposures and treatment patterns.

In accordance with another exemplary aspect of this invention the collection of the attitude, belief and opinion data is achieved by one or more of the following: surveys administered through the Internet or by mail, in-depth interviews conducted in-person or over the telephone, focus groups conducted in-person or over the Internet, and interactive voice response telephone surveys.

In accordance with another exemplary aspect of this invention the analyzing of the attitude, belief and opinion data comprises analyzing the data in one or more of the following manners: as a function of the nature and extent of sales representative promotional activities recorded by the physicians, as a function of the promotional messages perceived and recorded by the physicians, as a function of the extent to which patient treatment provided by the physicians varies, as a function of the access of the sales representatives to the physicians, as a function of the quantity of the encounters of the sales representatives to the physicians, as a function of the quality of the encounters of the sales representatives to the physicians, and as a function of the impact of the sales representatives on the treatment decisions of the physicians.

In accordance with another exemplary aspect of this invention changes in attitude, beliefs and opinions of the at least selected ones of the physicians is evaluated by conducting attritional research on their attitudes, beliefs and opinions at some future point in time.

In accordance with another exemplary aspect of this invention reports are provided regarding the attitudes, beliefs and opinions of the physicians. The reports may be in one perceptual maps and/or Point Vector Maps, and/or may be produced by simple cross-tab generation, by multiple regression analysis and/or other multi-variate techniques to assess stated versus derived importance, and/or verbatim analysis.

The system of this invention basically comprises a means for collecting promotional activity data from each of the physicians regarding the promotional activities of the sales representatives with respect to a single panel of a plurality of geographically diversified prescribing physicians and to specific pharmaceuticals to determine the promotional exposure to the physicians. A means for collecting treatment data from each of the physicians regarding the diagnosis and treatment of their patients with respect to the specific pharmaceuticals to determine the treatment patterns of said physicians also forms part of the system. As does means using the promotional activity data and the treatment data to establish the known history of promotional exposure to the physicians and known patient treatment patterns of the physicians and means for collecting attitude, belief and opinion data from at least selected ones of the physicians regarding their attitudes, beliefs and opinions with respect to the specific pharmaceuticals.

### DESCRIPTION OF THE DRAWING

FIG. 1 is a combination block/schematic diagram of a system constructed in accordance with one exemplary embodiment of this invention for carrying out one exemplary method of this invention;

FIG. 2 is a combination block/schematic diagram showing more details of the system shown in FIG. 1;

FIG. 3 is a block diagram of the details of the database forming a portion of the system of the subject invention;

FIG. 4 is a plan view of a hard-copy form used to collect data for use in the exemplary system shown in FIG. 1;

FIG. 5 is a front view of an exemplary data acquisition device, e.g., a PDA, used to collect data for use in the exemplary system shown in FIG. 1;

FIG. 6 is an illustration of various screens displayed by the data acquisition device shown in FIG. 5 to enable the collection of sales representatives visit data for use by the exemplary system shown in FIG. 1;

FIG. 7 is an illustration of various screens displayed by the data acquisition device shown in FIG. 5 to enable the collection of meetings and events data for use by the exemplary system shown in FIG. 1;

FIG. 8 is an illustration of an exemplary screen displayed by a data acquisition device, e.g., a laptop or personal computer, to enable the collection of data for use by the exemplary system shown in FIG. 1;

FIG. 9 is a functional block diagram showing a system and methodology for conducting primary research utilizing data acquired by the system 20 of FIG. 1 FIGS. 10A-10C are examples of a few exemplary questions for Internet-based collection of an exemplary primary research study involving antibiotic/anti-infective drugs conducted in accordance with the methodology shown in FIG. 9; FIGS. 11A-11L are representative exemplary slides of an slide-based output report for the exemplary syndicated primary research study utilizing the exemplary questions of FIGS. 10A-10C conducted in accordance with the methodology shown in FIG. 9;

FIGS. 12A-12K are representative exemplary slides of an slide-based output report for another exemplary syndicated primary research study which represents a follow-up or second wave of the study of FIGS. 11A-11L;

FIG. 13A are representative exemplary slides of an slide-based output report for an exemplary custom primary research study involving pharmaceutical company representatives qualities conducted in accordance with the methodology of FIG. 9; and

FIG. 14A-14D are representative exemplary slides of an slide-based output report showing the differences in a single attribute of the first and second wave studies of FIGS. 11 and 12.

### DETAILED DESCRIPTION OF THE PREFERRED EMBODIMENT

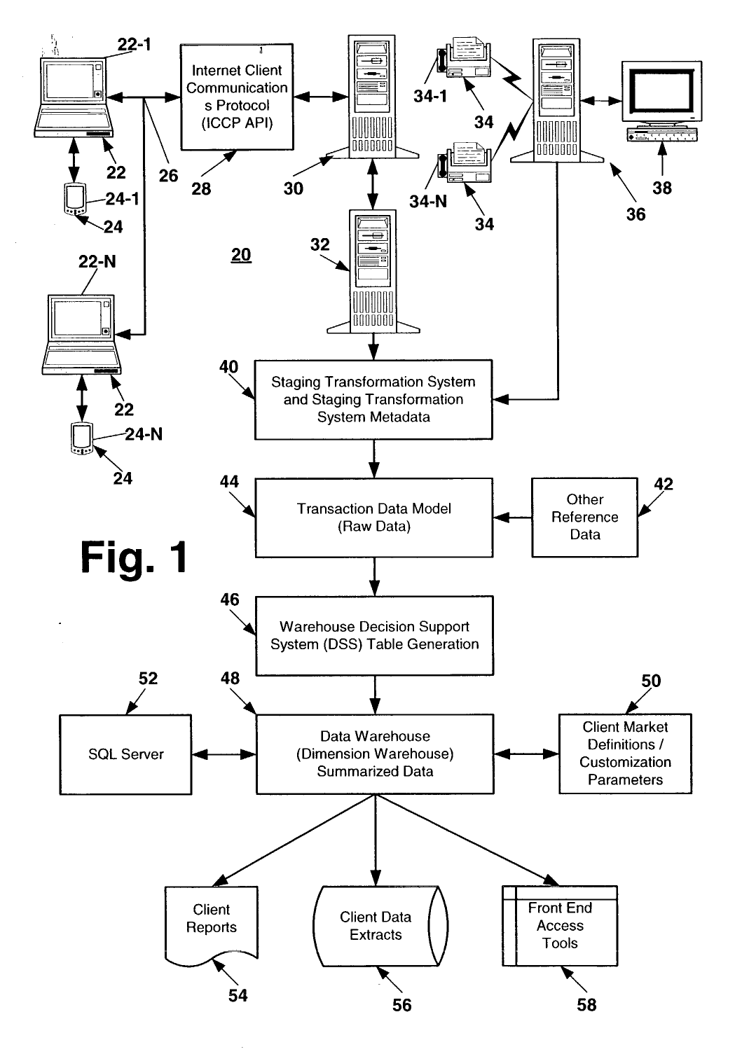

Referring to FIG. 1 there is shown at 20 in FIG. 1 a system for analyzing the performance of sales reps for pharmaceutical companies to determine their effect on pharmaceuticals prescribed for patients by the physicians that such reps engage. In accordance with one of the main aspects of this invention, the system 20 of this invention makes use of a single panel of prescribing physicians, e.g., at least 1000 general practice, family practice and internal medicine practice physicians, to collect the data. To facilitate the collection and capture of the data, each physician in the panel is given a laptop computer 22 and a personal digital assistant (PDA) 24. In FIG. 1 two lap-top computers 22-1 and 22-N and two PADs 24-1 and 24-N are shown. The lap-top computer 22-1 and the associated PDA 24-1 represent those input devices given to a first physician of the panel, whereas the lap-top computer 22-N and the associated PDA 24-N represent those input devices given to a Nth physician of the panel.

As will be described later, the physicians enter the data regarding promotional activities occurring at meetings or events outside their offices and data relating to the sales and promotional activities of the reps they encounter at their offices into their PDA. This information is then “hot-synched” or up-loaded into their lap-top computers 22. The data collected by the physicians relating to the diagnosis and treatment of their patients is entered directly into their laptops by the physicians. Each lap-top computer is arranged to be connected to an electronic communication network 26, in this case the Internet, to up-load the collected data into the system 20 and to download data and other information to the physicians' laptop computers 22. To achieve that end the system makes use of an Internet Client Communications Protocol or ICC API 28.

The raw data uploaded from the physicians via the Internet is collected on a Data Upload Server 30, hosted at some remote location and forming a portion of the system 20. The Internet Client Communication Protocol 28 provides a means to securely transmit information from the client data collection application the server 30 using a standard PPP communications session that runs over public networks (e.g., the Internet). The API for this protocol defines the methods by which the physicians communicate with the server. By using this API, the system 20 is able to eliminate all other forms of communication with the Web server 30, other that via this API, and greatly reduce the chances that the data or the server will be compromised in any way, despite their being exposed to the Internet.

The ICC API is broken down into six standard commands. These six ICC commands are invoked using the HTTP client “POST” mechanism, except for PITFALL, which uses the HTTP PUT method. The six commands are: LOGON (to log onto the server with a Username and Password), LOGOFF (to end the current login session), PING (to test connectivity between the physician and the server), PATRICK (to send a data record to the server for processing), GETFILE (to retrieve a named file from the server) and PITFALL (to transmit a file from the client to the server, via HTTP PUT). These six commands can accommodate the client-server communications needs of most applications. By versioning each command when it is transmitted, multiple versions of the ICC API can co-exist on the server, thus allowing a single server to host multiple, disparate applications, even if the applications support different, overlapping sets of commands. This API also enables the system 20 to leverage the public networks to communicate with its remote network of physicians. This communication includes the uploading of data input by the physicians to the system, and the downloading of new software versions to the physicians as the business changes. This electronic data collection results in unprecedented timeliness and quality of information regarding a physician's practice.

The web or Data Up-load Server 30 is connected, via any suitable electronic communications network, e.g., using FTP, to a Data Warehouse Server 32, located at another remote location and also forming a portion of the system 20. The Data Upload Server 30 and the Data Warehouse Server provide the data acquisition and processing for the system 20. In particular, the Data Warehouse Server 32 is where the relational database of the system resides. In one exemplary embodiment that database is Oracle-based and is updated nightly.

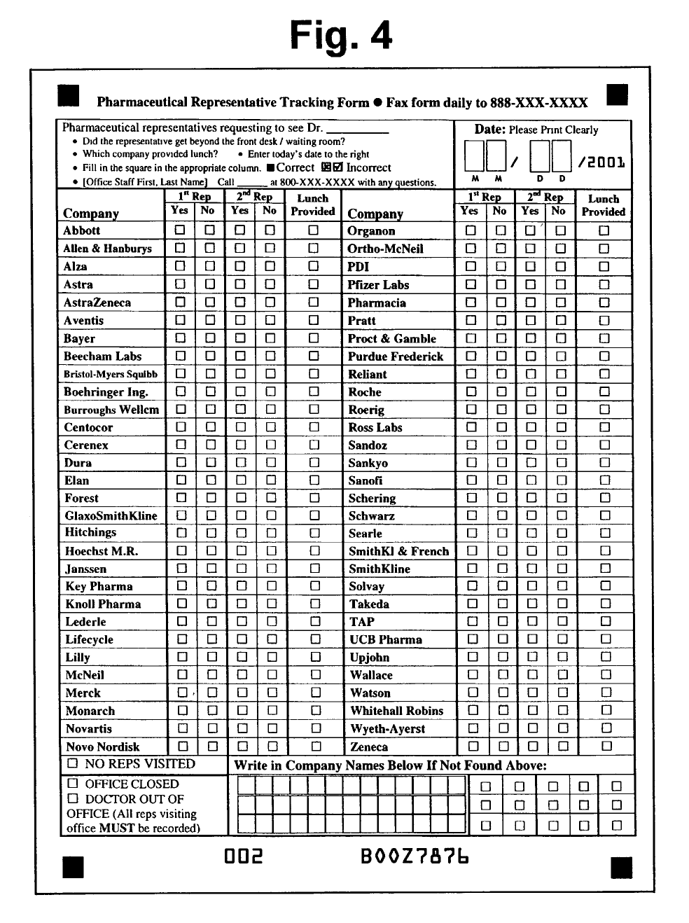

In this exemplary embodiment certain data, to be described in detail later and relating to the reps' access to the physicians of the panel, is collected by a designated person in the office staff of each physician of the panel. This data is collected manually by the designated person filling out a form, to be described later and shown in FIG. 4. That form is then sent by facsimile (FAX) from a facsimile machine 34 in the physician's office. In FIG. 1 two Fax machines 34-1 and 34-N are shown. These represent the fax machines of the first and Nth physicians, respectively, of the panel.

The fax data is collected by a Facsimile Server 36 located at some remote location and also forming a portion of the system 20. The faxed data is arranged to be processed to read it and to convert it to text files. This is accomplished by a OCR Forms Workstation computer 38 utilizing associated optical character recognition (OCR) software. The OCR Forms Workstation 38 is connected by a local area network to the Facsimile Server 36. The data from the two servers 32 and 36 is processed by a Staging Transformation System and Staging Transformation Metadata System portion 40 of the system 20 to transform the data into a normalized relational format and integrate it via standard processing keys.

The Staging Transformation System is a mechanism to use the Staging Transformation System Metadata to transform data between different data-models. These transformation processes can be adjusted to accommodate new business rules and new data simply by making adjustments to the metadata stored in the database. The transformation processing code reads the metadata from the database and processes the new data accordingly. The basic data processing algorithm used in the Staging Transformation System is: (1) load a row from the input staging table into the input record array, (2) perform input transformations on the input fields, (3) create and execute output record INSERT statements, composed of output fields that contain: (a) copies of transformed input fields, (b) constant values, (c) functional values (possibly using transformed input fields as parameters), and (d) macros, containing dynamic program values, and (4) repeat steps (1) through (3) for all remaining input records. Since a given input table row can source multiple output table rows, the processing in step (3) may occur multiple times for each input row loaded in step (1). The specific input and output processing that occurs in steps (2) and (3) is configured via the contents of the metadata tables. The rows in the various metadata tables are tied together for a particular processing run by a “job name.” The “job name” is an alphanumeric value that is stored in a column that appears in all tables in the metadata. The job name is passed to the Staging Transformation program on the command line.

In addition to the metadata, some environment-specific information is specified via a “configuration file.” These configuration parameters tend to be specific to a particular machine or database installation, while the information stored in the metadata is specific to a particular processing job (i.e., the input and output table formats).

The Staging Transformation System and Staging Transformation Metadata System enables the system 20 to maintain a highly flexible data maintenance environment, and react quickly to changes in business rules and data input variables. These changes can flow throughout the entire system relational processing stream, with minimal or no code changes to the system processing. Only the metadata in the tables is changed, and the new fields or business rules will be handled by the processing logic via the Staging Transformation System in a seamless manner.

The output from the portion 40 of the system 20 is normalized transaction records, created from de-normalized staging records. That output, along with Other Reference Data 42, is provided to the Transaction Data Model (Raw Data) portion 44 of the system 20. The data provided by the Other Reference Data is any data that the system makes use of to keep it current and accurate, e.g., update information about the various pharmaceuticals the system is arranged to evaluate, update information about the diagnoses (ICD9), and list of values for the application picklists (to be described later), etc. The Transaction Data Model (Raw Data) portion 44 of the system is arranged to represent the collected data in a normalized format for access and analysis. The output from the Transaction Data Model (Raw Data) portion 44 is transformed into a decision support star schema model, and is provided to the Warehouse Decision Support System (DSS) Table Generation portion 46 of the system 20. The portion 46 of the system 20 is arranged to facilitate reporting and analysis of the information. To that end, the output from the Warehouse Decision Support System (DSS) Table Generation 46 is a set of summarized fact and dimension tables, and is provided to another portion of the system 20, namely, the Data Warehouse (Dimension Warehouse) Summarized Data portion 48. The portion 48 is arranged to create final client deliverables (to be described later). To that end, the Warehouse (Dimension Warehouse) Summarized Data portion 48 is coupled to a portion 50 of the system called the Client Market Definitions/Customization parameters. The portion 50 is arranged to provide customized views of the data to clients. The Warehouse (Dimension Warehouse) Summarized Data portion 48 is also coupled to a SQL Server 52. The SQL Server 52 stores the database of physician information, e.g., name, address, and office and practice details. The SQL Server 52 is arranged to support the Customer Relationship Application (to be described later) for the physicians. The output of the Warehouse (Dimension Warehouse) Summarized Data portion 48 serves as the “deliverables” of the system 20, i.e., the information delivered to the various pharmaceutical company clients of the provider of the system 20. These outputs are in the form of Reports 54, Client Data Extracts 56 and Front End Access Tools 58. The Reports 54 are provided to the client in two manners. One manner is electronically and such reports consist of flat files and on-line documents. The other manner of document or report delivery is in hard copy format. A discussion of the contents of these reports will be set forth in detail later.

The Client Data Extracts 56 basically comprise detailed analysis of the information that has been customized using the Client Market Definitions/Customization portion 50 and are provided to the client in electronic and/or hard copy form.

Some clients may wish to be able to extract various information from the reports in a customized manner. To that end, such clients are provided with the Front End Access Tools 58. These tools basically comprise a way for the client to create their own reports and views of the data.

While not shown, the system 20 also includes a Customer Relationship Management (CRM) subsystem that allows the system 20 to track, monitor, and report on all interactions with the physician panel. The CRM subsystem includes a call center for receiving telephone calls from the physicians of the panel. In particular, each time a physician calls in to the system's call center, the call is recorded, and call history is displayed to enhance the interaction with the physician. This system also interacts with other portions of the system 20 by taking feeds of data from the data warehouse, so a physician's data upload history is known at the time of the call.

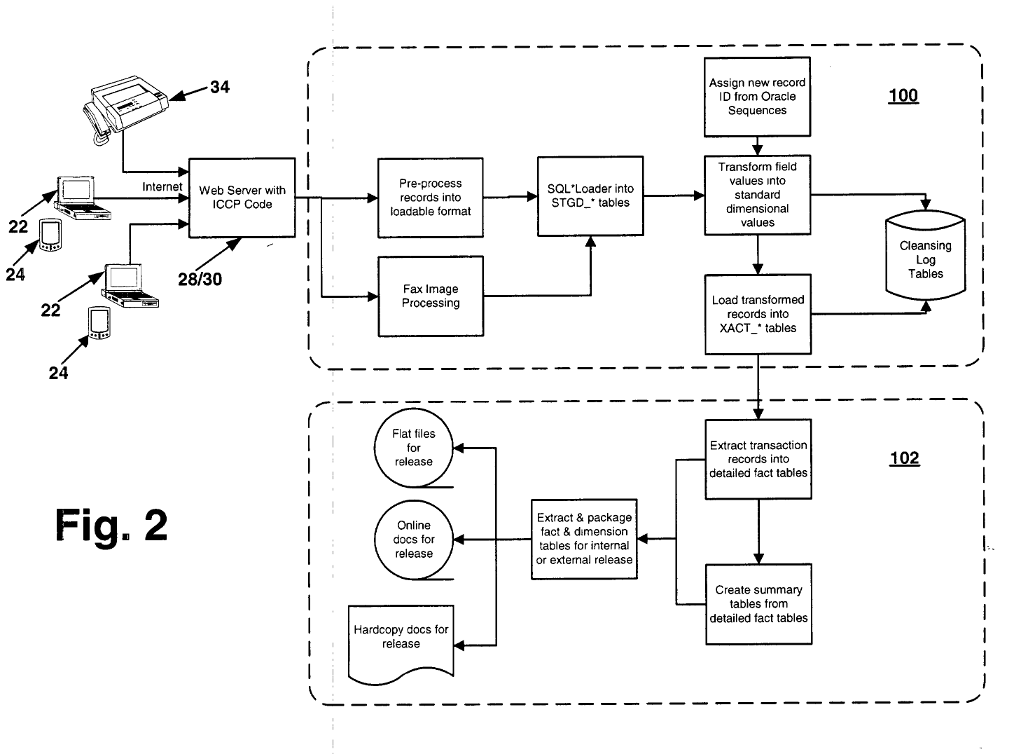

Turning now to FIG. 2 more details of the system 20 will now be described. To that end the functional operation of the database/application server portion of the system 20 is shown within the broken line box designated by the reference number 100, while the warehouse design support system (DSS) table generation portion of the system is shown within the broken line designated by the reference number 102. Thus, as can be seen the data from the web server with the ICC code is provided to the system portion 100 for processing of the raw text data uploaded by physicians into a relational table that contains the verbatim format. This data is parsed into fields using delimiters provided by the software. Once the data is loaded into the staging tables, it is then run through the record formatter, and using the processing metadata, is transformed into normalized tables to populate the transaction model. The output of the system portion 100 basically comprises the transaction tables and is provided to the system portion 102. That portion is arranged for processing into a star schema model to be used for analysis and reporting. The key metrics are transformed into dimensions and the non-key metrics are transformed into attributes. The reporting metrics are transformed into counts, and summed up into summary tables.

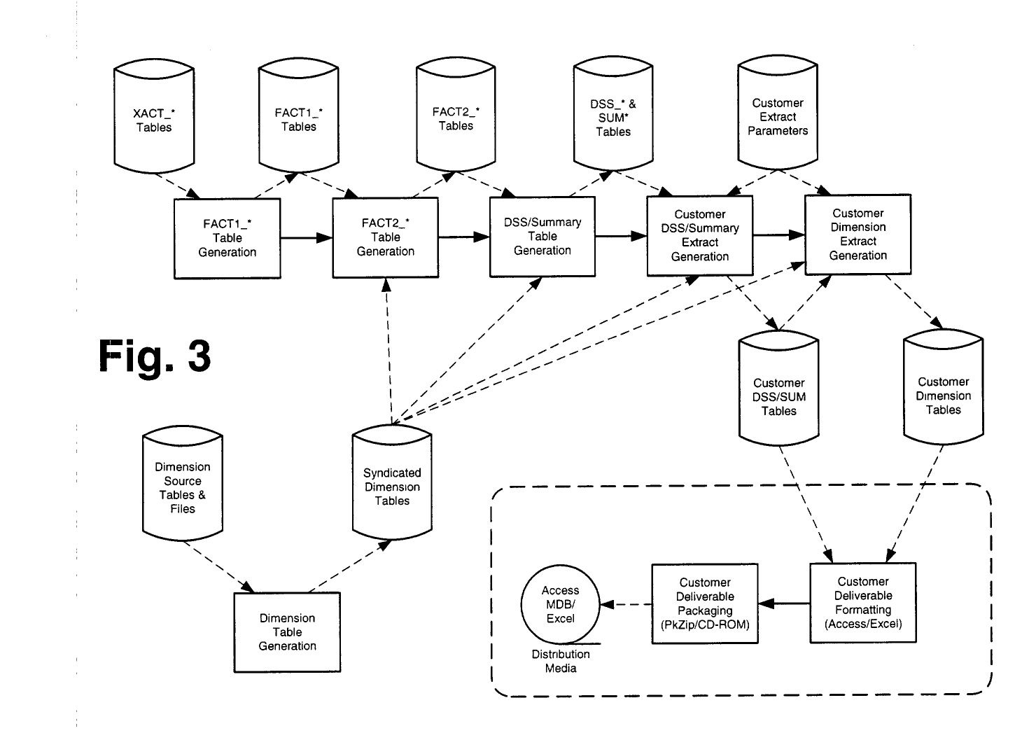

Turning now to FIG. 3 the details of the system's warehouse design support system (DSS) table generation portion 102 will now be described. To that end the warehouse model supports client specific extracts that are customized using the client's market definitions, and sub-setted into the segments of data that the client has purchased. The extract is packaged into deliverables using calculations, such as “share” (product share within a defined market definition, such as cholesterol lowering drugs) and “trending” (reporting information over time).

As can be seen in FIG. 3, the tables in the warehouse model are broken down into three main areas: fact tables, syndicated dimension tables, and customer specific dimension tables. The fact tables contain the business metrics that are to be reported on, such as the physician-intended prescriptions (to be described in detail later and referred to by the trademark metric IRx) and the physician-sales rep encounters (also to be described later). The fact tables can either be at the most granular level (base fact) or summarized to a higher level based on the hierarchy in one of the dimensions. The syndicated dimension tables contain all the possible values of a dimension, such as product, as well as the roll-up structures for that dimension, denormalized into a single table. An example of the roll-up structures for the product dimension is form strength to brand to therapeutic class.

The customer specific dimension tables contain the custom roll-up structures for particular dimensions that make the information meaningful to the client. An example of these roll-up structures is a set of products that comprise a market the way the client wants to view that market. The last type of customer specific dimension table is the extract parameters table. This defines the periodicity and dimension values that are to be provided to a given client for a given deliverable.

These dimension and fact tables together make up the warehouse model that supports a table driven, metadata based, flexible decision support environment for customizable client deliverables.

The type of data collected by the system of this invention and its manner of collection will now be considered. To that end the system of this invention collects more detailed, specific and relevant data than that collected by the prior art regarding the reps who visit the physicians. For example, as mentioned earlier the system 20 makes use of printed forms which is filled out for each rep who visits the office to capture data about that visit. This form used is called the “Activity Tracking Form” and an exemplary form is shown in FIG. 4. As can be seen therein the Activity Tracking Form comprises a table of the various pharmaceutical companies organized in horizontal rows and plural, e.g., two, columns for collecting information about the reps for each of those pharmaceutical companies who visit the office. The two rep columns are designated as “1^{st} Rep” and “2^{nd} Rep. Each of these columns is broken down into two sub-columns, “Yes” and “No,” with check boxes in each sub-column. The form is filled out for a particular rep of a particular company to indicate whether that rep actually saw the physician face-to-face by checking the appropriate “Yes” or “No” box. The form also includes a column designated “Lunch” with two sub-columns including respective check boxes to indicate whether or not the rep provided lunch. As can be seen the form includes other areas for collecting additional information, e.g., the date, etc. The form accommodates information about plural reps for each company, since more than one representative for a pharmaceutical company may visit the physician's office on a given day. Each visit by a rep for that particular company is noted on the form. This form is filled out by a designated person at the front desk of the physician's office. The complete form is then faxed daily to the Server 36, whereupon the form is scanned and OCR'ed to produce text files for daily uploading to the Data Warehouse Server for inclusion in the Staging Transformation System. If desired, the information from the received faxed form may be manually entered, e.g., keyed into the database, by personnel of the system provider.

As will be appreciated by those skilled in the art, those reps who get past the front desk don't necessarily get to have a face-to-face discussion with the physician, e.g., they may only gain access to the physician's drug sample storeroom to provide samples to the office, they may only pass the physician in a hall, etc. Thus, the Activity Tracking Form also captures data regarding competitive access along with the previously described competitive visit activity. Among the information provided to the pharmaceutical company clients of the system provider resulting from the collection and analysis of the data regarding competitive access is a metric, to be described in detail later, designated by the trademark “ACCESS RATING” by the assignee of this invention, ImpactRx, Inc. of Mt. Laurel, N.J. This rating represents the percentage of reps gaining access . Both of these pieces of information, that is, the visit and access are captured by the single Activity Tracking Form. Use of the commercial embodiment of this invention by the assignee has revealed that in typical cases approximately 65% of the reps that visit the office get beyond the front desk/waiting room of the physician, i.e., the reps have an ACCESS RATING of 65%.

The system 20 collects data from the physicians in the panel regarding their encounter with the sale reps to provide another metric or data piece, which is designated by the trademark “ENCOUNTER RATING” by the assignee of this invention. This metric represents the time that the rep actually has a personal encounter with the physician, whereas the ACCESS RATING metric indicates only that the rep has gotten beyond the front desk. The ENCOUNTER RATING metric represents any meetings with the physician. As mentioned earlier, on a industry-wide basis an ACCESS RATING of 65% has been determined. Insofar as those reps actually encountering or speaking to the physicians, it has been determined that on an industry-wide basis approximately 45% of those reps getting past the front desk actually encounter or speak to the physician, i.e., the ENCOUNTER RATING is 45%.

Another metric measured by the system of this invention is the “quality” of the encounter. The quality measurement is broken down into three categories or metrics. The first of those categories is where no pharmaceutical product is discussed. This type of encounter conversation between the sales rep and the physician may be small talk or chit-chat or about matters other than the products of the pharmaceutical company represented by the rep. The data regarding this metric is collected by the physician on his/her PDA (as will be described later) in a data field called “No Product Discussed.” It has been determined that of the 45% of the reps who have an encounter with the physician, fully 10% of those persons never discuss the pharmaceutical products with the physician, but rather discuss other things or merely exchange pleasantries.

The next of the three categories or metrics for quality is the so-called “One Way Discussion.” In this type of encounter the representative merely makes some statements about the pharmaceutical company's product, but gets no response from the physician. This could occur in the case where the rep merely passes the physician in the hall and says “Dr. Smith, don't forget when you have patients with high cholesterol to prescribe XYZ since it is very effective for your high LDL patients.” The data regarding this category or metric is collected by the physician in a data field called “One Way Discussion.” It has been determined that of the quality encounters, roughly 40% of such encounters are of a One Way Discussion.

The last of the three categories or metrics for quality is the so-called “Two Way Discussion.” In this encounter the rep gives the physician information regarding the pharmaceutical company's product(s) and the physician engages that rep in a conversation about that product(s). It has been determined that such two-way conversations occur approximately 40% of the time.

The subject invention may also collect data from the physician's on another type of encounter, namely, a combination of the one-way and two-way encounters. For example, in a combination encounter the rep may actually engage the physician in a discussion about one of the pharmaceutical company's products, where that conversation is a true two-way conversation, but then merely may present certain information about other of that pharmaceutical company's products to the physician but not engage the physician in any dialog regarding those other products. This is then the combination encounter. It has been determined that the combination of encounter occurs approximately 10% of the time.

Another metric used by the subject invention and captured by the physician on his/her PDA is designated as the “Message” metric. This metric is designed to indicate that the rep has delivered a desired information or message that the pharmaceutical company wants delivered to the physician, e.g., telling the physician that a particular drug requires only once daily dosing, has the benefit of reducing fractures, etc. It is the particular message delivered that ultimately has a major effect in driving the physician to prescribe a specific pharmaceutical company product. The subject invention captures the message or messages delivered by the reps. This should be contrasted with the prior art, wherein the messages collected typically have involved messages about safety, efficacy and dosage information and not the on-target messages which the sales reps are instructed to deliver to the physicians.,

The system 20 also captures, via the physicians, data regarding sales and promotional activities occurring at meetings or events. This meeting and event data entails encounters between the reps and the physicians occurring outside the office, such as at medical meetings and at social or professional events. Examples of such meetings and events are pharmaceutical company sponsored symposiums, etc.

Thus, as should be appreciated from the foregoing the subject invention enables the physicians of the panel to collect and capture data involving the activities of the sales reps for “details” occurring at either the physician's office, a hospital, clinic, nursing home, by telephone or by an Internet communication (sometimes referred to as a “eDetail”). This type of data can be referred to as the “Sales Rep Application.” In order to enable the physician to readily capture the Sale Rep Application, the PDA 24 provided to each physician includes software in it displaying various screens and fields for the physician to enter data regarding the various metrics measured. The data is entered into the PDA hot synched to the physician's laptop 22 and then periodically uploaded to system, e.g., uploaded five days per week. As will be described later the physician also captures diagnosis and treatment data for his/her patients. That data is entered directly into the physician's laptop computer 22 and uploaded to the system two days per week.

The various fields of information collected in the Sales Rep Application is shown in the following Table 1. In that table each of the various fields, e.g., is listed in the first column. For example, one of the fields is the date of the encounter or visit by the rep, designated by the field label “Visit Date” appearing in the first column. The description of the type of information for this field is listed in the last column. In this example, the Visit Date field is for data representing the date of the sales rep's visit. It is the date that the physician actually saw the sales rep, not the date that the record was entered or the date the record was uploaded. As can be seen from Table 1, some fields of data are required, by that it is meant they must be filled in by the physician, while others are optional. Thus, entry of a specific field's data is required in the Table's column next to the field name or label the word “Yes” will appear. The actual data that can be entered, for each field is designated in the Table 1 by the column bearing the heading “Possible Values.” Thus, for example, with respect to the Visit Date field, the physician can enter a valid date that is not in the future from the current date. The physician's PDA will default to the date the PDA is used to enter the data (as will be discussed in an example to follow), but the physician should over-ride that date if it is not the actual date he/she met with the rep. In Table 1 the values that are shown within quotation marks represent the choices of predetermined values that can be selected by the physician. For example, insofar as “Time Spent With Rep” is concerned the physician can select from either “<1 min,”” “1-3 min,” “3-5 min,” “5-10 min,” and “>10 min.”

TABLE 1
Sales Rep Application

| Field | Required | Possible Values | Description |
|---|---|---|---|
| Visit Date | Yes | A valid date that is not in | This is the date of the sales rep's visit. It is |
| | | the future from the current | the date the physician actually saw the sales |
| | | date | rep, not the date the record was entered, or |
| | | | the date the record was uploaded. |
| Company | Yes | From a picklist of | This is the name of the company of the |
| | | manufacturers/ | sales rep that is detailing the physician. |
| | | companies/sales forces | |
| Location of Detail | Yes | office, hospital, clinic, | This is the location where the encounter or |
| | | nursing home, phone, | detail was performed by the sales rep. |
| | | eDetail (Internet) | |
| Product Discussion | Yes | “<1 min,” “1-3 min ,” “3-5 | This choice indicates if the sales rep |
| | | min,” “5-10 min,” and “>10 | discussed a product with the physician or |
| | | min” | not. |
| Time Spent with | Yes | | This is the amount of time the rep spent with |
| Rep | | | the physician during the encounter. |
| Product Detail | No | Only required if “Product | Up to four products detailed during the |
| 1,2,3,4 | | Discussion” is selected | encounter. |
| Product | Yes | From a picklist of | The product that the sales rep discusses |
| | | products that the system | with the physician for the given detail |
| | | creates as brands that are | |
| | | promoted. | |
| One Way/Two Way | Yes | “One way” or “Two way” | This choice indicates whether the discussion |
| | | | for the given detail was a one way (only rep |
| | | | talks) or two way (a discussion where the |
| | | | physician asked questions or commented on |
| | | | the product). |
| Compared To | No | From a picklist of | The competitive product that the sales rep |
| | | products that the system | compared to the detailed product (if any). |
| | | creates as brands that are | |
| | | promoted. | |
| Sales Aid | Yes | “Electronic,” “Paper,” | The type of sales Aid used in the product |
| | | “Clinical Study,” “None” | discussion for the given encounter |
| Messages/Custom | Yes (at least one) | 14 standard messages or | These are the messages that the rep used |
| Messages | | up to 9 custom messages + | in the product discussion to promote the |
| | | 2 defaults | product that was discusses. These |
| | | | messages can either be from a standard set, |
| | | | or can be customized for a given product. |
| Message | No | Free Form Text (up to 256 | This is a space where the physician can |
| | | characters) | write any notes they want to regarding the |
| | | | product discussion |

Another type of data collected by the physicians of the panel involves any promotional activities directed to physicians at meetings and events attended by the physicians. This type of data is referred to as the “Meetings and Events Application” and is also input into the PDA by the physicians of the panel using various input screens. An example of such data entry will also be given later. The various fields of information collected in the Meetings and Events Application is shown in the following Table 2. Table 2 is similar to Table 1 in its organization. Thus, the field name or labels for various fields are listed in the first column. For example, one of the fields is the “Meeting Event Date.” The description of the type of information for this field is listed in the last column, e.g., “This is the date of the meeting/event. It is the date the physician actually attended the meeting/event, not the date the record was entered, or the date the record was uploaded.” Like Table 1, Table 2 has some fields which require data entry and some which are optional. So too, the actual data that can be entered, for each field is designated in the Table 2 by the column bearing the heading “Possible Values.” Thus, for example, with respect to the “Location of Event” field, the physician can select from one of the following choices “Entertainment Venue,” “Hospital,” “In Office,” “Internet,” “Phone,” “Restaurant,” “Weekend Symposium,” and “Other.”

TABLE 2
Meetings and Events Application

| Field | Required | Possible Values | Description |
|---|---|---|---|
| Meeting Event Date | Yes | A valid date that is not in | This is the date of the meeting/event. It is |
| | | the future from the current | the date the physician actually attended the |
| | | date | meeting/event, not the date the record was |
| | | | entered, or the date the record was |
| | | | uploaded. |
| Sponsor | Yes | From picklist of | This is the company that is sponsoring the |
| | | manufacturers/ | event. |
| | | companies/sales forces | |
| Location of Event | Yes | “Entertainment Venue,” | This is the location where the event was |
| | | “Hospital,” “In Office,” | held. |
| | | “Internet,” “Phone,” | |
| | | “Restaurant,” “Weekend | |
| | | Symposium,” “Other” | |
| Topic | Yes | Freeform text | The physician enters the topic of the |
| | | | meeting. |
| Topic Quality | Yes | 1 to 7 | The quality of the topic as perceived by the |
| | | | attending physician. 1 is low and 7 is high. |
| Location Quality | Yes | “Excellent,” “Very Good,” | The quality of the location as perceived by |
| | | “Good,” “Fair,” “Poor” | the physician. |
| Product | No | From a picklist of | The product that was discussed at the |
| | | products that the system | meeting (if any). |
| | | creates as brands that are | |
| | | promoted | |
| Nature | Yes | “No Product Discussed,” | The nature of the meeting as described by |
| | | “Investigational Drug,” | the choices at left. |
| | | “Product Specific” | |
| Program Length | Yes | “<30 Min,” “31 Min-1 hour,” | The length of the program. |
| | | “1-2 hours,” “2-4 | |
| | | hours,” “>4 hours,” | |
| | | “overnight” | |
| Speaker | No | Freeform Text | The name of the speaker |
| Speaker Info | No | “Local Specialist,” | The type of speaker |
| | | “Regional Thought | |
| | | Leader,” “National | |
| | | Thought Leader” | |
| Attendee Count | Yes | 1 to 99999 | The number of attendees at the meeting |
| CME Credits | No | Yes or no | Indicates whether the physician is able to |
| Offered | | | earn CME credits at the meeting. |

The last type of data collected by the physicians of the panel is the data relating to the diagnosis and treatment of their patients to be correlated to the promotional activities of the reps. This type of data is referred to as the “Patient Application” and is also input into either the PDA or laptop by the physicians of the panel using various input screens on the PDA and/or laptop. Examples of such data entry will also be given later. The various fields of information collected in the Patient Application is shown in the following Table 3. Table 3 is similar to Tables 1 and 2 in its organization. Thus, the field name or labels for various fields are listed in the first column. For example, one of the fields is the “Visit Date.” The description of the type of information for this field is listed in the last column, e.g., “This is the date of the patient visit. It is the date the physician actually saw the patient, not the date the record was entered, or the date the record was uploaded.” Like Table 1, Table 2 has some fields which require data entry and some which are optional. So too, the actual data that can be entered, for each field is designated in the Table 2 by the column bearing the heading “Possible Values.” Thus, for example, with respect to the “Insurance” field, the physician can select from one of the following choices “Cash,” “HMO/PPO/POS,” “Indemnity,” “Medicaid,” “Medicare,” “None,” and “Not Known.”

TABLE 3
Patient Application

| Field | Required | Possible Values | Description |
|---|---|---|---|
| Visit Date | Yes | GT 1/1/2001 and less | This is the date of the patient visit. It is the |
| | | than current date. The | date the physician actually saw the patient, |
| | | exception is that 1/1/2000 | not the date the record was entered, or the |
| | | is allowed for test upload | date the record was uploaded. |
| | | records | |
| Age | Yes | 0 to 119 | This is the age in years of the patient. |
| | | | Physicians can enter 0 as the age for infants |
| | | | less than 1 year old. |
| Gender | Yes | M or F | The gender of the patient |
| Insurance | Yes | “Cash,” “HMO/PPO/POS,” | This is the type of insurance the patient has. |
| | | “Indemnity,” “Medicaid,” | |
| | | “Medicare,” “None,” “Not | |
| | | Known” | |
| Location | Yes | “Clinic,” “Hospital,” | This is the location the physician saw the |
| | | “Nursing Home,” “Office,” | patient. |
| | | “Other,” “Phone” | |
| Diagnosis (1, 2 or 3) | Yes | From Diagnosis List | This is the Diagnosis of the patients illness. |
| Diagnosis Type | Yes | “Newly Diagnosed,” | This is the type of diagnosis for the patient's |
| | | “Previously Diagnosed” | illness. If a physician has previously seen a |
| | | | patient for a given condition, he/she will |
| | | | check “Previously diagnosed.” Otherwise |
| | | | the physician will check “Newly Diagnosed.” |
| Severity | Yes | “Mild,” “Moderate,” | This is the severity of the patients diagnosis. |
| | | “Severe” | |
| Non Drug Treatment | No | “Diet,” “Rest,” “Exercise,” | This is the type of non drug treatment the |
| | | “Alternative,” “Other” | physician has given to the patient for the |
| | | | given diagnosis. |
| Patient Requested | Yes (yes or | From picklist of all drugs | This is the drug that the patient requested |
| Drug | no required) | tracked by the system | for the given diagnosis (if any) |
| Rx1, Rx2, Rx3 | No | Not required (well visit) | The following fields are part of the |
| | | | prescription (Rx) information for a given |
| | | | diagnosis. |
| Product name | Yes | From picklist of all drugs | The name of the product the physician |
| | | tracked by the system | prescribed for the given diagnosis. |
| Form Strength | Yes | From picklist of | The form/strength for the given Rx. |
| | | form/strengths for the | |
| | | given drug | |
| Rx, Rx with Sample, | Yes | One of the 3 must be | This allows a physician to indicate whether |
| Sample Only | | checked | there was a sample provided with the Rx, or |
| | | | whether a sample and no Rx was given. |
| Dispensed | Yes | 1 to 999 | The quantity dispensed for the given Rx. |
| Schedule | Yes | “1 per week,” “1 per | The schedule that the patient will take the |
| | | month,” “BID,” “QD,” | given Rx. |
| | | “QID,” “TID,” “PRN,” | |
| | | “Q6H,” “Q8H,” “Other” | |
| Refills | No | 1 to 999 | The number of refills for the given Rx. |
| Change | | | |

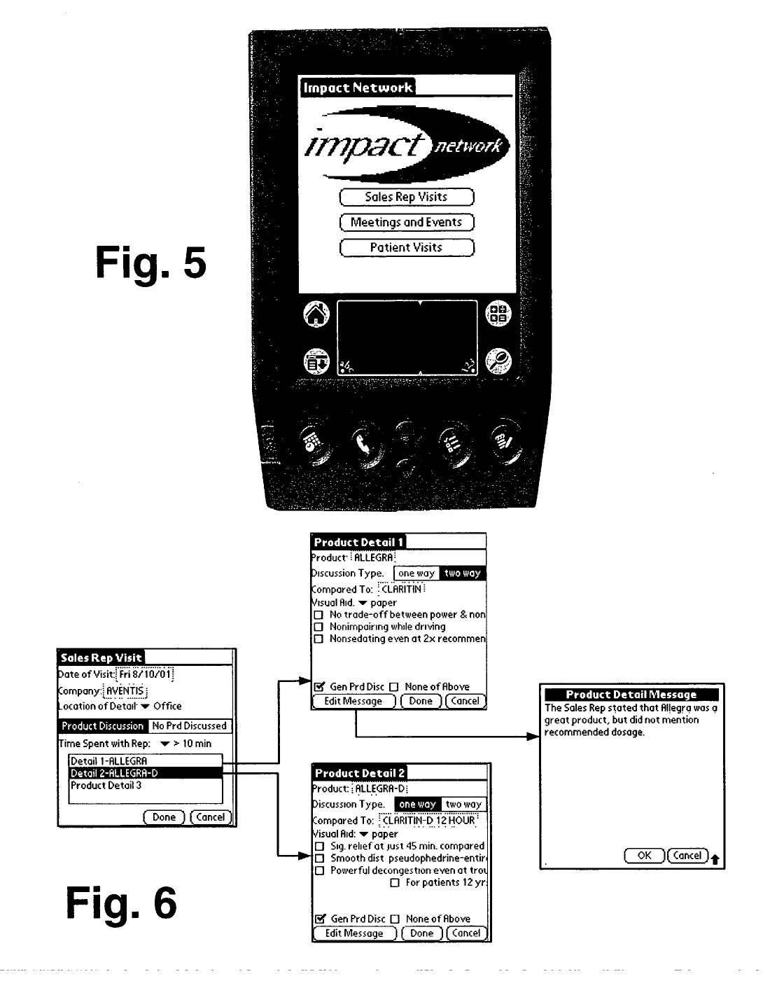

The following is are examples of the entry of Sales Rep Application data by the physician into his/her PDA 24, as shown in FIGS. 5-7. In the first of these example it is assumed that the physician is entering information regarding his/her encounter with a sales representative of a pharmaceutical company at his/her office. Thus, as can be seen in FIG. 5, the physician has to select one of two buttons appearing on the first screen of his/her PDA, namely, either the “Sales Rep Visits” button or the “Meetings and Events” button. Since this example is for an office visit, the “Sales Rep Visits” button is actuated to automatically bring up the first screen of the Sales Rep Visit module. That screen is shown as the left-most screen in FIG. 6. The date of the encounter or visit is entered automatically by the PDA's internal clock and is displayed on the PDA's screen in the box entitled “Date of Visit” unless the physician did not meet with the rep on that date. If that is the case the physician enters the actual date of the encounter with the rep (as defined in Table 1 above). The physician next has to select the identity of the pharmaceutical company that the rep represents. This is accomplished by clicking on the box next to the word “Company” on the PDA screen, whereupon a drop down or pick list of the various pharmaceutical companies is displayed. The physician clicks on the appropriate company and that company's name now appears in the box. In this example, it shall be assumed that the company for whom the rep is detailing is Aventis. Alternatively, the name of the company can be manually entered in the box. The next item of information to be entered is the location of the encounter. This is accomplished by the physician clicking on the drop-down or pick-list arrowhead next to the words “Location of Detail.” In the example shown the physician has selected “Office” since that is where this exemplary encounter has occurred. If no product was discussed the physician enters this information by clicking on the box bearing the words “No Prd Discussed.” If, however, a product is discussed the physician enters this information by clicking on the box bearing the words “Product Discussion.” In this case a product was discussed so that the box with the words Product Discussion is highlighted. The time spent for this encounter is entered by the physician clicking on the drop down list arrowhead next to the words “Time Spent with Rep:.” In the example shown the physician has selected “>10 min.”

The selection of the pharmaceutical(s) discussed is then recorded by the physician clicking on any of the terms “Product Detail 1,” “Product Detail 2,” or “Product Detail 3” appearing in a large box below the “Time Spent With Rep” field. In the example shown the physician has already entered information about a first product discussed, namely, Allegra, and that information has been recorded in the PDA as “Detail 1.” The product discussed in the second discussion, i.e., the product discussed in this example, is Allegra-D and that is entered by the physician clicking on “Product Detail 2,” whereupon a pick-list of “Aventis” products is displayed, from which the physician selects the one discussed, e.g., Allegra-D. This selection is then displayed as “Detail 2-ALLEGRA-D.”

Once the physician has completed this screen he/she clicks on the “Done” button to enter the data into the PDA's memory. This action brings up the next screen to enable the entry of information about the encounter with respect to the second of the “detailed” drugs, in this case, ALLEGRA-D. This screen is shown as the bottom-most of the middle two screens shown in FIG. 6. The uppermost of the middle two screens of this figures shows the information previously entered by the physician for the first detailed drug, namely, ALLEGRA. With respect to the second detailed drug, the screen displays the name of the drug ALLEGRA-D next to the word “Product.”

The physician then enters information regarding the quality of the encounter, e.g., whether it entailed a one-way discussion (the rep speaking about the drug, but not engaging the physician in a dialog about the drug) or a two-way discussion (a dialog between the rep and the physician about the drug). In this example the encounter regarding ALLEGRA-D was a one way discussion. Next the physician enters information about any competitive drugs that may have been discussed by clicking on the box next to the word “Compared To” on the PDA's screen. This action cause a pick-list of the various competitive drugs to ALLEGRA-D to be displayed on the screen. The physician clicks on the appropriate drug and that drug's name now appears in the box. In this example the physician selected “CLARITIN-D 12 HOUR.” The physician then enters information regarding any visual aids that were used, by selecting the appropriate data from a pick-list next to the words “Visual Aid.” In this case a visual aid paper was used.

The physician then enters additional information regarding the encounter in the nature of the type of message delivered by the rep. As mentioned above, each pharmaceutical company has some specific message or messages that it wants its reps to convey about each of its drugs. This data is contained in the system's database and is loaded into the PDA where it resides when the physician hot synchs his/her PDA. Thus, the system can update the messages desired to be communicated about each product to the physicians so that they can determine if the sales reps have conveyed those messages to them. In the example shown there are three tailored messages desired to be conveyed, about ALLEGRA-D. Each of these tailored messages is displayed on the PDA screen with a check box next to it. Accordingly, the physician can check off each message conveyed to him/her by the rep to indicate that the desired message was delivered. In this example none of the boxes is checked. Instead the physician has checked the box bearing the words “Gen Prd Disc.” located below the tailored message boxes. This indicates that the discussion about ALLEGRA-D was a general product discussion. There is also a check box bearing the words “None of Above” which is provided for the physician to check if the encounter didn't entail any discussion of tailored messages or a general product discussion. Below those check boxes is a button bearing the words “Edit Message.” This is provided to enable the physician to click on it to open a window into which he/she can enter any information he/she cares to make about the encounter. In this example, the physician did not select the Edit Message button for Product Detail 2. Thus, once this screen is completed, the physician clicks on the button bearing the word “Done” to enter that data into the PDA's memory for subsequent uploading to the system. In the example of FIG. 6, it can be seen that the physician had selected the “Edit Message” button on the Product Detail 1 screen to open the Product Detail Message screen as shown in the right-most screen in FIG. 6. In this example, the physician entered “The Sales Rep stated that Allegra was a great product, but did not mention recommended dosage.”

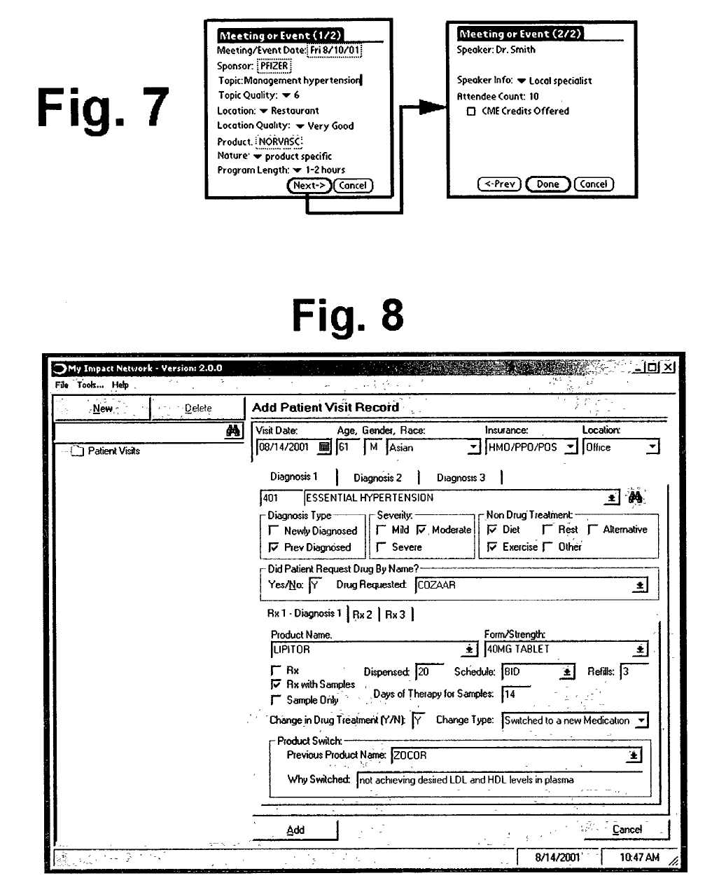

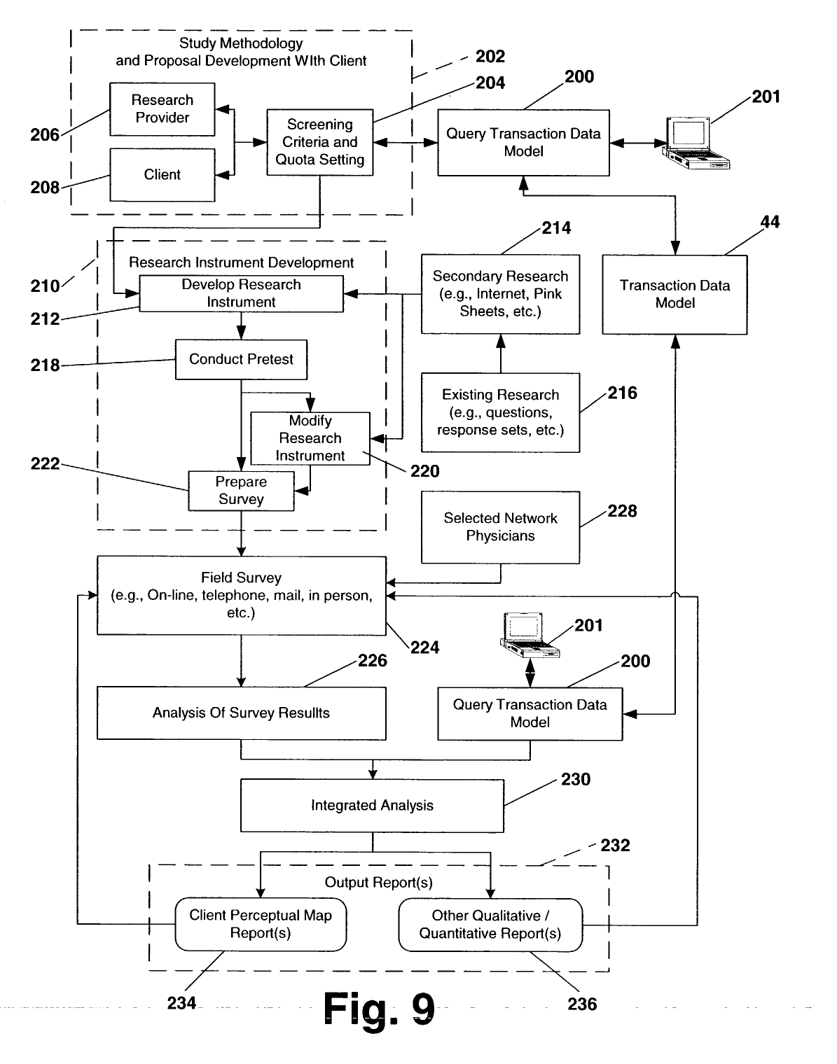

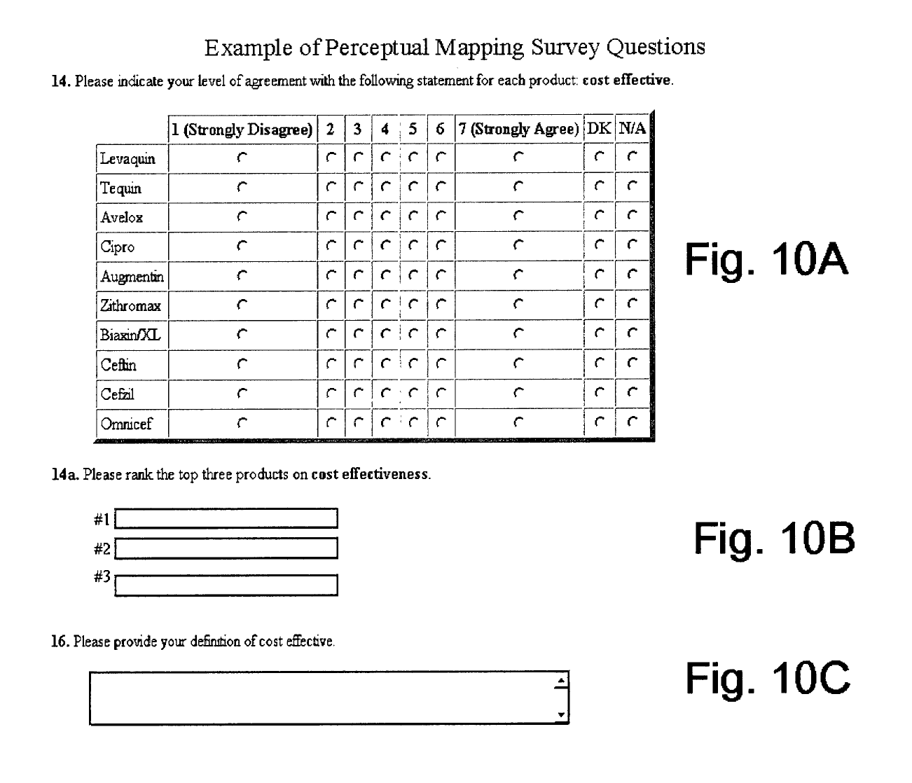

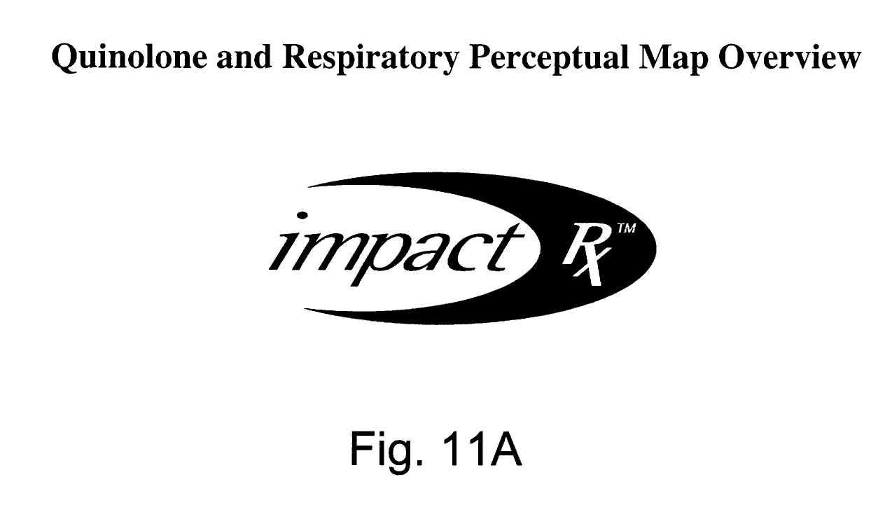

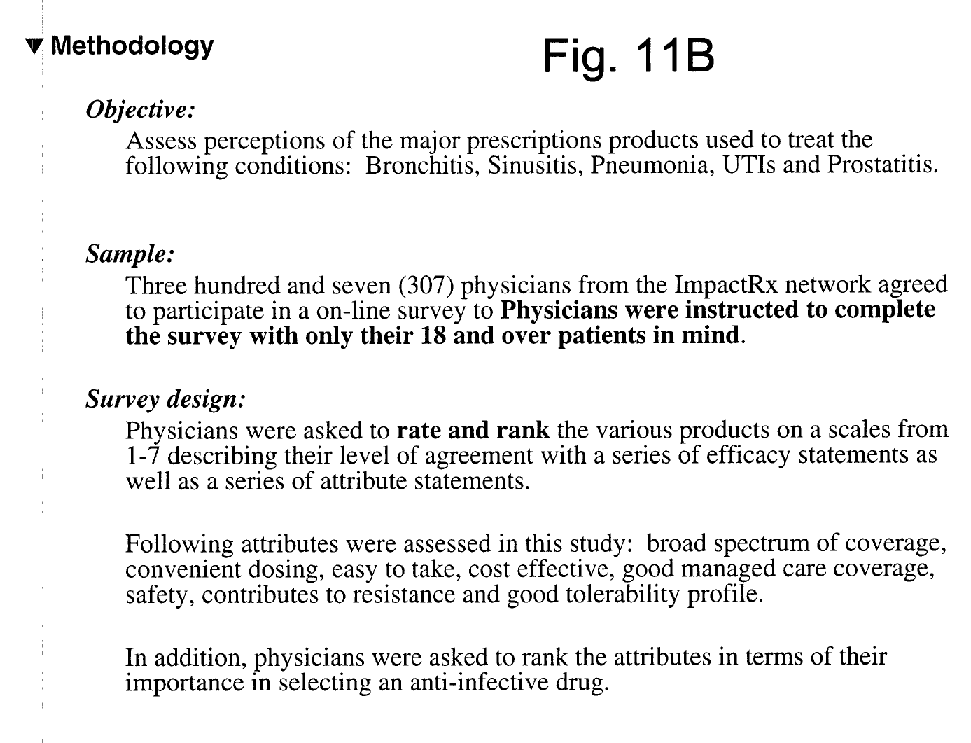

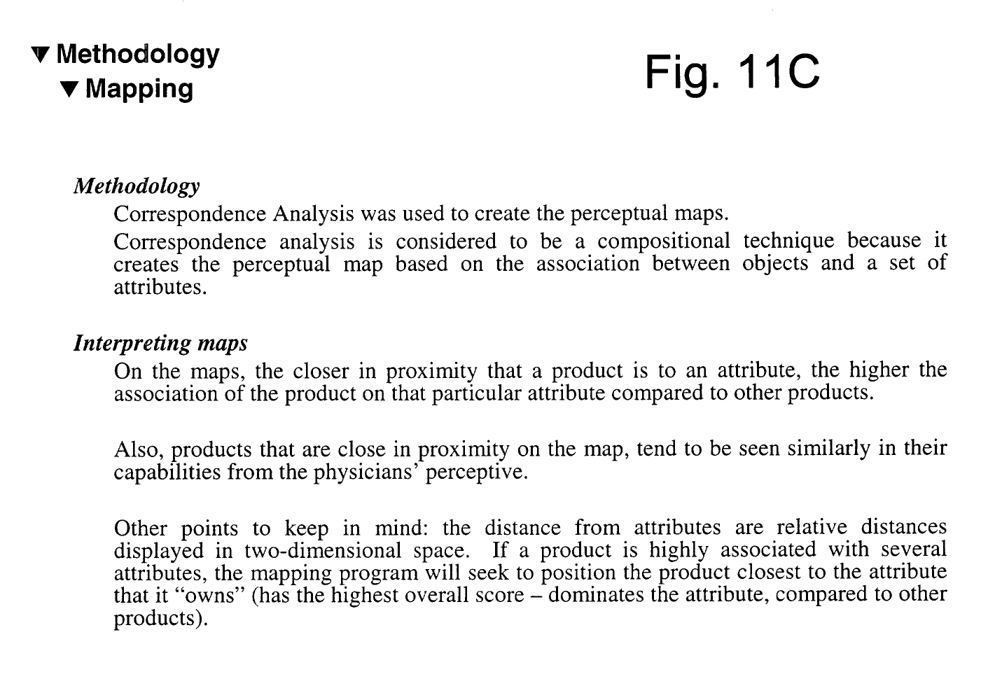

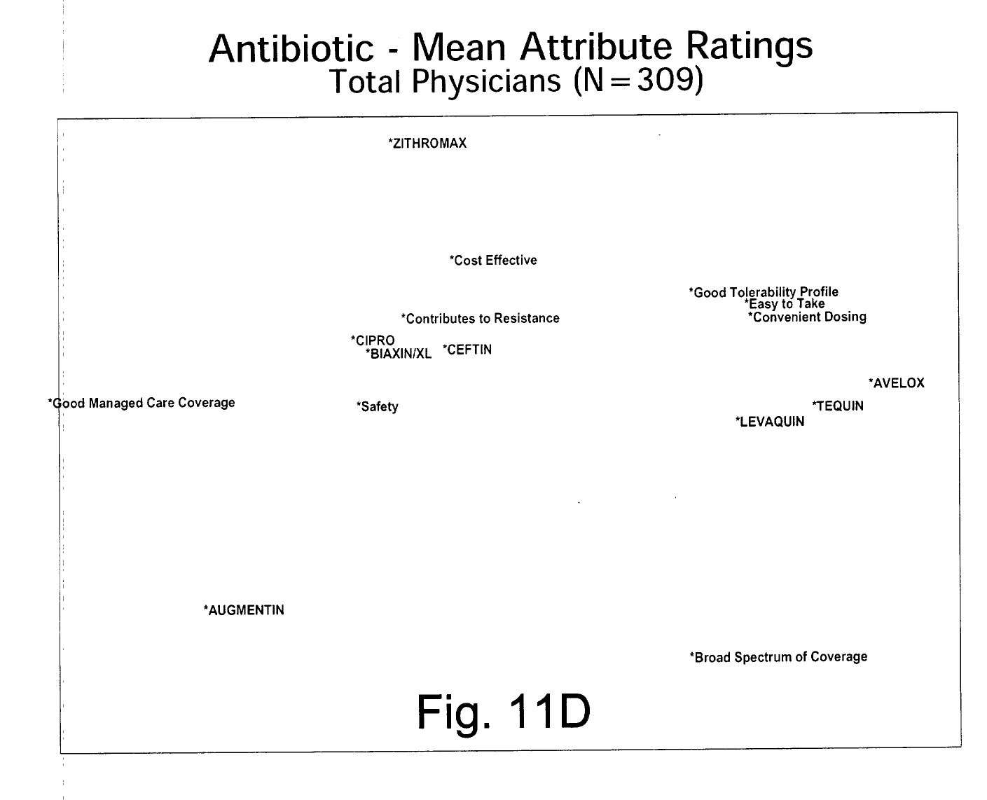

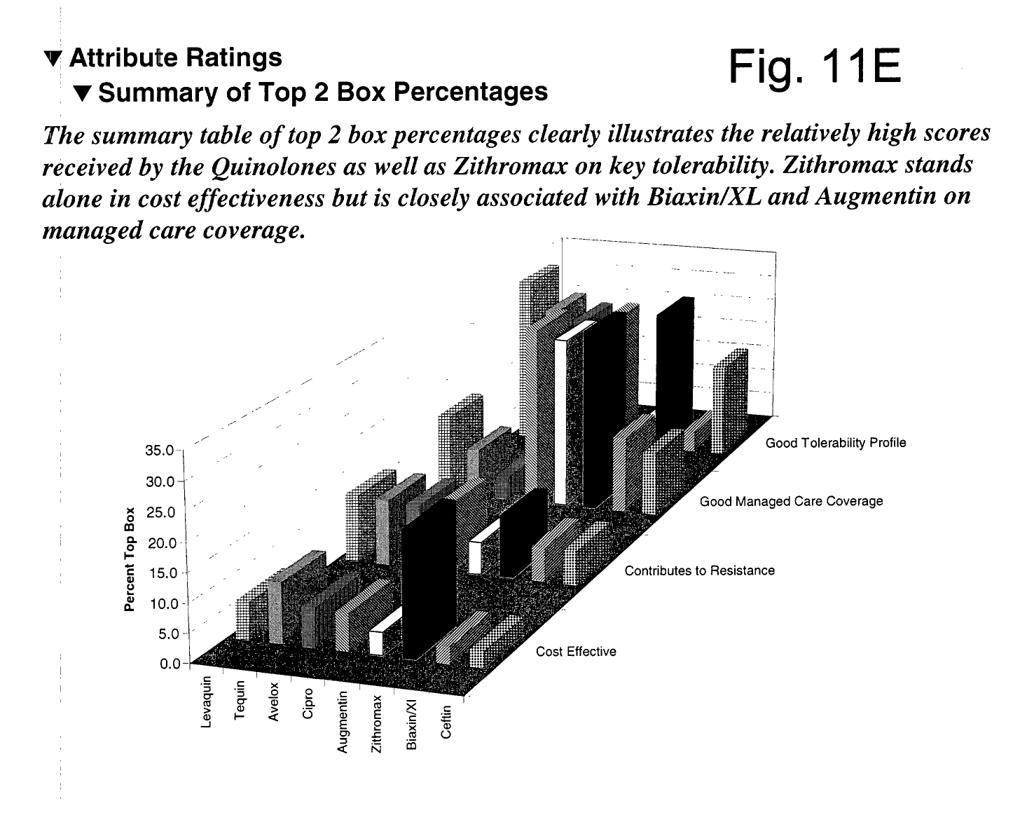

In FIG. 7 there is shown the PDA that a physician has entered information about a meeting or event. Thus, as can be seen, the first screen selected by the physician to enter this information, i.e., the left-most of the two screens in FIG. 7, displays the heading “Meeting or Event (½).” Below that heading there is a box for the entry of the date of the meeting or event. The date of the is entered automatically by the PDA's internal clock and is displayed on the PDA's screen in the box entitled “Meeting/Event Date.” The physician can enter a different date, if that date is not the actual date of the meeting or event being recorded. If that is the case the physician enters the actual date of the meeting or event (as defined in Table 2 above). The physician next has to select the identity of the pharmaceutical company that sponsored the meeting or event. This is accomplished by clicking on the box next to the word “Sponsor” on the PDA screen, whereupon a drop down or pick list of the various pharmaceutical companies is displayed. The physician clicks on the appropriate company and that company's name now appears in the box. In this example, it shall be assumed that the sponsoring company is Pfizer. Alternatively, the name of the company can be manually entered in the box. The next item of information to be entered is the topic discussed. This is accomplished by the physician manually entering the topic on the line next to the word “Topic.” In this example, the topic entered is “Management hypertension.” The next item of information collected is the quality of the discussion/presentation on the topic. This is accomplished by clicking on the drop-down list or pick-list arrowhead next to the words “Topic Quality.” In the example shown the physician has selected a numerical value of “6” (see Table 2, above, for the various entries that can be selected for this metric). The next item of information collected is the location of the meeting or event. This is accomplished by clicking on the drop-down list or pick-list arrowhead next to the words “Location.” In the example shown the physician has selected “restaurant” (see Table 2, above, for the various entries that can be selected for this metric). The next item of information collected is the quality of the location. This is accomplished by clicking on the drop-down list or pick-list arrowhead next to the words “Location Quality.” In the example shown the physician has selected “Very Good” (see Table 2, above, for the various entries that can be selected for this metric). The next item of information collected is the identity of the pharmaceutical company product discussed or promoted at the event. This is accomplished by selecting the appropriate drug from the pick list in box located next to the word “Product.” In the example shown the physician has selected “NORVASC” (see Table 2, above, for the various entries that can be selected for this metric). The next item of information collected is the nature of the discussion or promotion with respect to the selected drug. This is accomplished by selecting the entry from the pick list in box located next to the word “Nature.” In the example shown the physician has selected “product specific” (see Table 2, above, for the various entries that can be selected for this metric). The next item of information collected is the length of the program. This is accomplished by selecting the entry from the pick list located next to the words “Program Length.” In the example shown the physician has selected “1-2 hours” (see Table 2, above, for the various entries that can be selected for this metric).

That last selection ends the data being captured by the first screen of the meetings and events module. To go to the next screen, shown as the right-most screen in FIG. 7, the physician clicks on the “Next” button on the bottom of the first meetings and events screen. When the second screen opens, the physician can enter the identity of the speaker in the lines appearing next to the word “Speaker.” In this example the physician entered the name “Dr. Smith.” The next item of information collected is information about the speaker, e.g., Dr. Smith. This is accomplished by selecting the entry from the pick list located next to the words “Speaker Info.” In the example shown the physician has selected “local specialist” (see Table 2, above, for the various entries that can be selected for this metric). The next item of information collected is information about the number of attendees. This is accomplished by manually entering a number on the line located next to the words “Attendee Count.” In the example shown the physician has enter “10” (see Table 2, above, for the various values that can be selected for this metric). The last item of information collected is if CME (Continuing Medical Education) credits are given for this meeting or event. This is accomplished by checking the box located next to the words “CME Credits Offered” if the attendance at the meeting or event warrants such credits. The completion of the collection of meeting and event data is achieved by clicking on the button marked “Done” at the bottom of the second screen.

As mentioned above, physicians also capture diagnosis and treatment data for use by the system 20 to be correlated to the sales and promotional activities of the pharmaceutical company reps. The diagnosis and treatment information is entered by the physician into the laptop computer at the time that the physician is working on the particular patient's chart. At this time the physician enters in all of the data regarding the diagnosis and treatment of the patient, e.g., what drugs the physician prescribed, how that prescription will be delivered to the patient (e.g., by samples, by the filling of the prescription by a pharmacy or by a combination of the two). The treatment information collected not only includes the identity of the drug, but the form strength level of the drug prescribed. The physician also collects information regarding if there was a drug switch, e.g., was the patient switched from one drug to another and if so, from what to what. The physician also collects as part of the diagnosis and treatment data, some data heretofore not collected, namely, if the patient suggested a particular drug that he/she may have seen advertised or heard about.

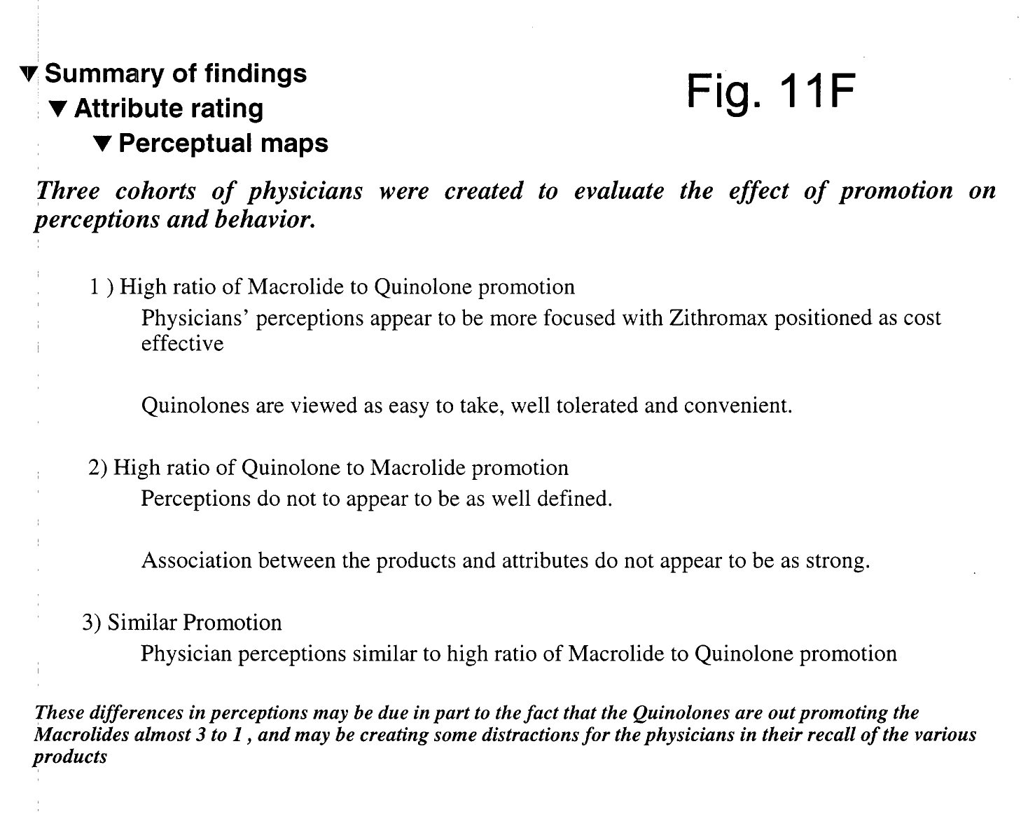

The details of the type and manner of collection of the diagnosis and treatment data will now be described with reference to FIG. 8 which shows screens of the physician's lap-top computer for entering the relevant data. As mentioned earlier, this information can also be entered into the PDA. In either case the diagnosis and treatment information is entered by the physician at the time that he/she enters information into the patient's chart. This data is collected and entered two days per week by the physicians of the panel, so roughly 40% of the total number of patients seen by each physician of the panel can be correlated to the sales and promotional activities of the pharmaceutical company reps by the analysis of the data in the system.

As can be seen the first item of information to be entered is the date of the patient's visit to the physician. This is entered automatically by the lap-top's internal clock and is displayed on the lap-top's screen in the box under the words “Date of Visit,” unless the patient's visit did not occur on that date. If that is the case the physician enters the actual date of the visit (as defined in Table 3 above). The physician next enters data regarding the patient's age, gender and race in the boxes under the words “Age,” “Gender” and “Race,” respectively. The values/entries that can be placed in these boxes are shown in Table 3. In the example shown, the patient is a 61 year old, male Asian. The physician next enters data regarding the patient's insurance, if any. This is accomplished by clicking on the downward pointing arrow for the box under to the word “Insurance” on the screen, whereupon a drop down or pick list of the entries or values for this category is displayed (see Table 3, above, for the various entries that can be selected). The physician clicks on the appropriate entry and that now appears in the box. In this example, the data “HMO/PPO/POS” has been selected. The next item of information to be entered is the location of the patient visit, e.g., whether in the office, in a clinic, in a hospital, etc. This is accomplished by clicking on the downward pointing arrow for the box under to the word “Location” on the screen, whereupon a drop down or pick list of the entries or values for this category is displayed (see Table 3, above, for the various entries that can be selected). The physician clicks on the appropriate entry and that now appears in the box. In this example, the word “Office” has been selected.

The system of this invention enables the physician to enter data for up to three diagnoses in the system. These three diagnoses are identified by the tabs on the lap-top screen bearing the words “Diagnosis 1,” “Diagnosis 2” and “Diagnosis 3.” To enter data for the first diagnosis the physician clicks on the Diagnosis 1 tab, whereupon his/her lap-top screen looks like FIG. 8. The physician can then enter information about this first diagnosis. To that end, the first item of information to be entered is the ICD-9 code for the diagnosis. This is accomplished by clicking on the left-most box under Diagnosis 1 tab, whereupon a drop down or pick list of the entries or values for this category is displayed (see Table 3, above, for the various entries that can be selected). The physician clicks on the appropriate entry and that now appears in the box. In this example, the code “401” has been selected. Upon the entry of this code, the words “essential hypertension” which is the diagnosis represented by code 401 appears in the box to the right of the box bearing the code. This entry is automatically provided by the system. Alternatively, the physician can enter the words “essential hypertension” into that box, by selecting it from the pick-list for that box (see Table 3, above, for the various entries that can be selected), whereupon the system 20 will cause the ICD-9 code “401” to appear in the right-most box. The next item of information to be entered is the diagnosis type, i.e., whether the diagnosis is new or previously diagnosed. This data is entered into the appropriate check box next to one of the words “Newly diagnosed” and “Prev Diagnosed.” In this example the box “Prev Diagnosed” has been selected. The next item of information to be entered is the severity of the diagnosed condition, i.e., whether mild, moderate or sever. This data is entered into the appropriate check boxes next to the words “Mild,” “Moderate” and “Severe.” In this example the box “Moderate” has been selected. The next item of information to be entered is the type of non-drug treatment given by the physician. This data is entered into the appropriate check box(s) next to the words “Diet,” “Exercise,” “Rest,” “Other” and “Alternative.” In this example the boxes “Diet” and “Exercise” have been selected.

The next item of information to be entered is if the patient requested a drug by name. This data is entered into the box under to the words “Did The patient Request Drug By Name?” from the choices yes (“Y”) or no (“N”). In this example, yes (“Y”) was selected. The next item of information to be entered is the name of the drug requested. This is accomplished by clicking on the downward pointing arrow for the box next to the words “Drug Request” on the screen, whereupon a drop down or pick list of all of the drugs tracked by the system 20 appears. The physician clicks on the appropriate entry and that now appears in the box. In this example, the drug “COZAAR” has been selected and appears in that box.

The system of this invention also enables the physician to enter data for up to three prescriptions intended for the diagnosis selected. These three prescriptions are identified by the tabs on the Diagnosis 1 screen of the lap-top computer bearing the words “Rx 1 Diagnosis 1,” “Rx 2 Diagnosis 1” and “Rx 3 Diagnosis 1.” To enter data for the first diagnosis the physician clicks on the Rx 1 Diagnosis 1 tab, whereupon his/her lap-top screen looks like FIG. 8. The physician can then enter information about the first prescription for that diagnosis. The first item of information to be entered for that prescription is the name of the drug requested. This is accomplished by clicking on the downward pointing arrow for the box under to the words “Product Name” on the screen, whereupon a drop down or pick list of all of the drugs tracked by the system 20 appears. The physician clicks on the appropriate entry and that now appears in the box. In this example, the drug “LIPITOR” has been selected and appears in that box. The next item of information to be entered for that prescription is the form strength of the drug requested. This is accomplished by clicking on the downward pointing arrow for the box under to the words “Form/Strength” on the screen, whereupon a drop down or pick list of all the form/strength for that particular drug appears. The physician clicks on the appropriate entry and that now appears in the box. In this example, the drug “40 MG TABLET” has been selected and appears in that box. The next item of information to be entered is how the prescription is to be provided to the patient, i.e., whether by prescription (Rx), a prescription with samples, or by samples only. This data is entered into the appropriate check boxes next to the words “Rx,” “Rx with Samples” and “Sample Only.” In this example the box “Rx with Samples” has been selected. The next item of information to be entered for that prescription is the amount to be dispensed. The number of doses is entered into the box next to the word “Dispensed.” In this example the number 20 has been entered. The next item of information to be entered for that prescription is the schedule for the taking of the drug by the patient. This is accomplished by clicking on the downward pointing arrow for the box under to the words “Schedule” on the screen, whereupon a drop down or pick list of the various schedule times appears (see Table 3, above, for the various entries that can be selected). The physician clicks on the appropriate entry and that now appears in the box. In this example, the frequency of “BID” has been selected and appears in that box. The next item of information to be entered for that prescription is the number of days of therapy for the samples. This number is entered into the box next to the words “Days of Therapy for Samples.” In this case the amount entered is 14.

The next item of information to be entered for that prescription is if the physician switched the prescription from a previous different product. If so the physician enters the name of the previous prescription drug in the box appearing next to the words “Previous Product Name.” The name of the previous prescription is selected from the drop down list of all of the drugs tracked by the system 20. The physician clicks on the appropriate entry and that now appears in the box. In this example, the drug “ZOCOR” has been selected and appears in that box. If there was a drug switch, the physician now enters the reason for the switch in the box next to the words “Why Switch.” In this case the physician has entered “not achieving desired LDL and HDL levels in plasma” as the reason for the switch.

The physician can then enter data about a second and third diagnosis in the same manner. Once all of the data has been entered, the physician clicks on the “Add” (in the case where the data is entered into the laptop) or “Done” (in the case where the data is entered into the PDA) button at the bottom of the screen to enter all of that data in the patient's file for subsequent uploading to the system server.

As should be appreciated from the foregoing, by collecting the information from the physicians who are actually doing the prescribing, as accomplished by the system of this invention, a much more accurate picture is developed regarding the effectiveness of the pharmaceutical companies detailing than had heretofore been possible by merely looking at prescription that are dispensed from various pharmacies. In this regard, the prior art techniques of using a collection of data from large national or regional pharmacies regarding dispensed drugs does not reveal the true causal connection picture. In this regard, the drugs that are actually dispensed by the pharmacy may not be the drugs that the physicians prescribed. For example, a generic drug may be substituted by the pharmacy, a health maintenance organization or other insurer may require that a different drug be given, etc. Thus, the collection of data regarding what drugs were ultimately dispensed to the patient does not indicate the correlation between what the physician intended the patient to get and what the patient actually gets.

As will be described shortly, the system of the subject invention provides an output metric of the “intended prescription” that is the prescription actually given by the treating physician, in response to being confronted by the various reps of the various pharmaceutical companies. This metric presents a highly accurate picture of the effectiveness of the pharmaceutical company's detailing and represents the benchmark metric for gauging the effectiveness of a pharmaceutical company's detailing process. Thus, by utilizing a single universe of physicians collecting the promotion data as well as the diagnosis treatment and intended prescription data, the subject system can provide a very accurate picture of the cause and effect of a pharmaceutical company's detailing procedures.

The output data provided by the system, i.e., the data representative of the analyzed input data, is provided primarily in electronic form to the pharmaceutical company clients of the system provider. That output data includes various unique metrics that quantify aspects of the promotional activities of the sales reps. The first metric to be discussed and referred to generically as “Metric No. 1,” is a grade provided to the companies with regard to their sales reps' ability to gain access to the physician office. In an embodiment of this invention provided by the assignee of this invention, Metric No. 1 is designated by the trademark “ACCESS RATING” and represents the percentage of time that the sales reps are successful in getting past the front desk and are in a position to see the targeted physician face-to-face. The second metric, designated as Metric No. 2, grades the companies with regard to their sales reps' ability to encounter the physician face-to-face. Metric No. 2 is designated by the assignee of this invention by the trademark ENCOUNTER RATING and represents the percentage of time the sales reps are successful in getting past the front desk of the physician's office to be able to see the targeted physician face-to-face.

Among the data analyzed to produce the aforementioned metrics, the database of the system 20 keeps track in the database of the total office visits, i.e., the sum total of all sales rep visits to the physician office as recorded by the designated office staff personnel. The sum total of all sales reps that gain access to the physicians (as also recorded by the designated office staff) are also collected and included in the database as the “Total Office Access Counts.” The sum total of all sales reps' face-to-face engagements with the physicians (as also recorded by the designated office staff personnel) is also collected and included in the database as the “Total Physician Encounters.”

As discussed earlier, the system collects four different types of sales rep-physician engagements. These engagements are referred to as the “encounter type” and consist of the following: “no product discussed,” “one way discussion,” two way discussion,” and “meeting and event.” As also discussed, if the sales rep had a face-to-face discussion with the physician but no product was discussed, this “No Product Discussed” data is recorded by the physician and collected for the database. A one way discussion comprises a face-to-face discussion that results only in the sales reps speaking. A two way discussion is a face-to-face discussion that results with both the sales rep and the physician engaged in a product discussion.

From the foregoing data, Metric No. 1 (the ACCESS METRIC) is calculated by taking the total office access counts and dividing that by the total office visits. Metric No. 2 (the ENCOUNTER RATING metric), is calculated by taking the total physician encounters and dividing that by the total office visits.

The system of the subject invention provides one other unique metric, designated as Metric No. 3. The Metric No. 3 grades companies in relation to the number of intended prescriptions generated from a single sales rep-physician encounter and is designated by the trademark “PROMO RATING” by the assignee of this invention. To calculate Metric No. 3 data is collected regarding all prescriptions written by the physician for specific product/company combination. This data is designated by the trademark “INTENDED PRESCRIPTION” or “IRx” by the assignee of the subject invention. The PROMO RATING metric of any particular product is calculated by taking the new or total IRx metric and dividing it by the total product discussions. The PROMO RATING metric of any particular company is calculated by taking the new or total IRx metric and dividing it by the total company encounters.

The report output of the subject invention also includes a measure of the frequency of product level encounters in conjunction with subsequent physician prescribing patterns. This report (sales representative activity optimization) is provided to the company clients and is based on various data collected and analyzed. That data includes the sum total of all sales rep' face-to-face engagements with the physician (the “Total Physician Encounter”). In addition, the sum total of all prescriptions written for a specific product on an individual patient-diagnosis basis is collected and used in the database and is referred to as the “Total Intended Prescription.” The data also collected includes the sum total of all product specific prescriptions written for the first time on an individual patient-diagnosis basis. This is referred to as the “New Intended Prescription.” In addition, the sum total of all product specific prescriptions written for at least the second time on an individual patient-diagnosis basis is collected and provided in the database. This is referred to as the “Renewal Intended Prescription.” Further still, the sum total of all product specific prescriptions written for the first time, where a previous product therapy existed on an individual patient-diagnosis basis, is also collected and provided in the database. This is referred to as the “Switch Intended Prescription.” Lastly, the database includes the percentage of physicians engaged in a defined number of encounters within a given time frame. This is referred to as the “Percentage Of Physicians Linked To Encounters.”

Another report provided by the subject invention is the “Drug Mention Impact Report.” This report measures the effect of product-level patient drug mentions (DTC generated) impact on physician product prescribing. This report is based on the sum total of all prescriptions written for a specific product on an individual patient-diagnosis basis, the sum total of all product specific prescriptions written for the first time on an individual patient-diagnosis basis, the sum total of all product specific prescriptions written for at least the second time on an individual patient-diagnosis basis, and the sum total of all product specific prescriptions written for the first time where a previous product therapy existed on an individual patient-diagnosis basis.

Another report provided by the subject invention is the “Diagnosis/Drug Mention Impact Report.” This report measures the effect of product-level patient drug mentions (DTC generated) impact on the physician product prescribing within a given diagnosis. This report is based on the sum total of all prescriptions written for a specific product on an individual patient-diagnosis basis, the sum total of all product specific prescriptions written for the first time on an individual patient-diagnosis basis, the sum total of all product specific prescriptions written for at least the second time on an individual diagnosis basis, the sum total of all product specific prescriptions written for the first time where a previous product therapy existed on an individual patient-diagnosis basis, and the sum total of patient visits for a particular diagnosis.

Another report provided by the system is the “Sales Rep Encounter Type Distribution Report.” This report details the product level mix of sales rep-physician encounters. The product-level encounter types are one-way discussions, two-way discussions and meeting and events. This report is based on the sum total of all sales rep face-to-face engagements with the physicians, the encounter types (whether one-way discussions, two-way discussions or meeting and events).

Another report provided by the system measures the frequencies of sales rep product level encounters in relation to specific product discussion order slots. This report is based on data regarding the product that was discussed as the first detail within an encounter (called the product priority No. 1 encounter), the product that was discussed as the second detail within the encounter (referred to as the product priority No. 2 encounter), and so on.

Another report provided by the subject invention is the “Meeting and Event Time Distribution Report” which details the product level mix of physician attended meetings and events in relation to the length of time for each program. This report is based on data regarding the total time spent by the physician at each individual attended meeting and event. As discussed earlier, these times are recorded by the physician as one of the following: less than 30 minutes, 31 minutes to one hour, one to two hours, two to four hours, greater than four hours and overnight.

Another report provided by the system is the product intended prescription distribution report (referred to as the “Product Distribution Report”). This report details the measurement of the product level physician prescribing (new, renewal or switch) within a defined competitive matrix. This report is based on the sum total of all prescriptions written for specific product on an individual patient-diagnosis basis, the sum total of all product specific prescriptions written for the first time on an individual patient-diagnosis basis, the sum total of all product specific prescriptions written for at least the second time on an individual patient-diagnosis basis and the sum total of all product specific prescriptions written for the first time where a previous product therapy existed on an individual patient-diagnosis basis.

Another report provided by the subject system details individual product-product prescribing patterns at an individual diagnosis level. This report is known as the “Concomitant Product Intended Prescription Distribution Report.” Individual product information is provided for when the product is used alone and in combination with other products for a single diagnosis. This report is based on the sum total of all prescriptions written for a specific product on an individual patient-diagnosis basis, the sum total of all product specific prescriptions written for the first time on an individual patient-diagnosis basis, the sum total of all product specific prescriptions written for at least the second time on an individual patient-diagnosis basis, the sum total of all product specific prescriptions written for the first time where a previous product therapy existed on an individual patient-diagnosis basis and whether the prescribed product will use alone for indicated diagnosis (referred to as product used alone) or whether the prescribed product was used in conjunction with another product for the indicated diagnosis (referred to as the concomitant products).

Another report provided by the system details the competitive product level mix of prescriptions within individual diagnoses and is referred to as the “Diagnosis/Product Intended Prescription Distribution Report.” This report is based on the sum total of all prescriptions written for a specific product on an individual patient-diagnosis basis, the sum total of all product specific prescriptions written for the first time on an individual patient-diagosis basis, the sum total of all product specific prescriptions written for at least the second time on an individual patient-diagnosis basis, and the sum total of all product specific prescriptions written for the first time where a previous product therapy existed on an individual patient-diagnosis basis.

Another report provided by the system of this invention details the competitive product level mix prescriptions within individual, new and previous diagnosis types. This report is referred to as the “Diagnosis Type/Product Intended Prescription Distribution Report.” This report is based on the sum total of all prescriptions written for a specific product on an individual patient-diagnosis basis, the sum total of all product specific prescriptions written for the first time on an individual patient-diagnosis basis, the sum total of all product specific prescriptions written for at least the second time on an individual patient-diagnosis basis, the sum total of all product specific prescriptions written for the first time where a previous product therapy existed on an individual patient-diagnosis basis, the diagnosis being treated by the physician for the first time (referred to as the newly diagnosed), and the diagnosis for which the individual patient has been previously treated (referred to as the previously diagnosed).

Another report provided by the system of this invention details the intended prescription distribution for a product by diagnosis. This report is referred to as the “Product/Diagnosis Report” and is based on the sum total of all prescriptions written for a specific product on an individual patient-diagnosis basis, the sum total of all product specific prescriptions written for the first time on an individual patient-diagnosis basis, the sum total of all product specific prescriptions written for at least the second time on an individual patient-diagnosis basis, and the sum total of all product specific prescriptions written for the first time where a previous product therapy existed on an individual patient-diagnosis basis.

The foregoing reports are merely exemplary of many variations of reports that can be produced in accordance with the teachings of the invention. For example, an output report may include a measure of what can be called the “Physician Promotion Response,” that is the response of the physician (as measured by the IRx metric) to promotion (in the form of pharmaceutical rep activity).

It should be pointed out at this juncture that the system and method described heretofore to provide what can be referred to a “linked core information” is merely exemplary and many variations can be made to them within the scope of this invention. For example, it is contemplated that the system and method can be used to link core information with pharmaceutical company call file record information. In particular, the linked core information could be linked at an individual pharmaceutical company level to that company's call files. As is known, the call file is a self-reported record kept by the sales representatives of physician encounters or details. Linking the linked core information produced by the subject invention and as described above with the collected information of the company call file will enable comparative analysis' of encounter activity. Specifically, such a system will provide the ability to discern true call activity and the delta between self-reported call activity and physician reported encounter activity.

It is also contemplated to link the linked core information produced by the subject invention with pharmaceutical company sample file record information. In particular, the linked core information could be linked at an individual pharmaceutical company level to that company's sample files. As is known the sample file is a FDA-mandated reporting record of product samples provided to individual physicians. Linking the linked core information to the company sample file will enable comparative analysis' of sales representative office-level activity. Specifically, such a system will provide the ability to discern true office activity levels and the difference between sample activity and physician office staff reported office activity.

It is also contemplated to link the linked core information produced by the subject invention with pharmacy-level dispensed product prescription information. In particular, the core claim information could be linked at an individual pharmaceutical company level to that company's respective dispensed product information. Pharmacy-level dispensed product information would be provided by a third-party vendor (e.g., IMS Health or NDC Health, Inc. of Atlanta, Ga.). Linking the linked core information to the dispensed product prescription information will enable comparative analysis' of the delta between physician intended and pharmacy dispensed product prescription information.

It is also contemplated to link the linked core information produced by the subject invention with patient-level disease treatment and managed care organization (M.O.) information. In particular, the linked core information could be linked at an individual pharmaceutical company level to specific patient disease treatment and M.O. product information. Both the patient disease treatment and M.O.-level information would be provided by a third-party vendor. Linking the linked core information to both the patient disease treatment and M.O. information will enable comparative analysis of the entire Patient-Provider-M.O. disease treatment continuum.

As should be appreciated from the foregoing the subject invention focuses on a specific universe of physicians, and it only uses that one universe for the collection of both marketing data and disease and treatment data. That universe comprises primary care, high-volume prescribing physicians (e.g., general practitioners, but may comprise other physician specialties, as well). This is a subset of the general universe of physicians that have been used in the past for each of the two panels. Moreover, and quite significant, It is these primary care, high-volume prescribing physicians that the pharmaceutical industry targets for its promotional activities. Thus, by collecting the promotional and diagnosis and treatment information from this one panel of physicians, the subject invention enables one to accurately assess the correlation between the promotional activities of the reps and the diagnosis and treatment provided to the patients. Thus, the system 20 of the subject invention provides much more accurate and relevant information to the pharmaceutical companies.

As will also be appreciated by those skilled in the art the system 20 described heretofore enables one to conduct extremely accurate and relevant research based on various sources of secondary information, something the prior art was unable to do. Since that system 20 provides accurate information about the treatment/prescribing behavior of the physicians in its network or panel and the promotional activities of the pharmaceutical companies directed to them, the system 20 can serve as a vehicle for enabling one to conduct very accurate primary market research to determine the attitudes, beliefs and opinions of the physicians with respect to the drugs promoted.

It should be pointed out at this juncture, that the subject invention is not limited to studies for the pharmaceutical industry. Thus, this invention can be used in other medical fields as well, e.g., the medical device industry, etc.

Market research studies are defined in two broad categories, namely, primary (custom) and secondary (syndicated) studies. Primary market research studies are developed with specific objectives and are usually designed to meet the needs of a single client. These studies are sometimes referred to as custom or proprietary studies. Secondary market research studies are designed to meet the needs of many clients by exploring issues at more of a macro level, while primary or proprietary market research explores issues at the micro level. One example of custom primary research may be a study conducted by or for a pharmaceutical company that wishes to reposition one of its drugs in the marketplace and wants to determine how physicians perceive that a particular brand drug.

Both primary and secondary market research studies are further subdivided into qualitative and quantitative studies. Qualitative and quantitative studies can be defined by the methodologies that are used to collect information as well as the sample sizes requirements. Qualitative studies involve smaller sample sizes and usually employ data collection techniques that provide depth of information. Typical data collection techniques used in qualitative studies include: in-depth in-person & telephone interviews, focus groups (on-line and in-person), and mini groups, (on-line and in-person). These data collections are designed to elicit conversations that go beyond the responses that are generated from open-ended questions that are included in quantitative studies. The research instrument for qualitative research is typically a discussion guide. Discussion guides allow the researcher or moderator to guide a discussion. Qualitative interviews are typically conducted by seasoned market researchers who have been trained as moderators, to direct discussions to achieve the stated research objective without reading a series of question word-for-word.

Quantitative studies use larger sample sizes to enable researchers to make statistical inferences about a group or segment of respondents. Larger sample sizes are required to conduct many of the statistical tests often employed to test for differences between the responses of various segments. The techniques used to collect quantitative data include: mail survey, on-line surveys, computer aided telephone surveys (CATI), interactive voice response (IVR) surveys.

Irrespective of the type of primary research study being conducted, it typically consists of asking specifically designed or tailored questions of the physicians chosen for the study. Heretofore such questions have been directed to those physicians which the researcher infers are appropriate to provide the answers sought. However, as set forth in detail above, the prior art techniques are grossly insufficient to accurately determine the appropriate physicians to query. In contradistinction, by using the system 20 and methodology described above appropriate physicians from the panel or network can be selected as the subjects for the primary research study, since their actual promotional history (e.g., the promotional activities to which they have been exposed) and their actual treatment/prescription activities/patterns are known. Thus, the promotions to which they have been exposed and their treatment or prescription patterns are not surmised or inferred as has been the case in the prior art. In short, and as will be understood from the discussion to follow, selection of physicians from the network or panel to be the subjects for the primary research study can be targeted based on a variety of criteria captured by the system 20. This feature enables clients of the research company utilizing the subject invention to develop research studies that are very targeted and tactical in nature, as well as studies that seek to understand high volume prescribing physicians in general, which can then serve to be strategic in nature.

In conducting primary market studies researchers commonly make use of the technique called multidimensional scaling (MDS), also known as perceptual mapping. This is a procedure that allows researchers to determine the perceived relative image of a set of objects (products, companies, or other items associated with commonly held perceptions). The purpose of MDS is to transform judgments of similarity or preference into distances represented in multidimensional space. Perceptual mapping techniques can be classified by the nature of the responses obtained from the individual concerning the object (product). The two types are compositional and decompositional. Compositional designs measure attribute associations, while decompositional designs measure only the overall impression of a product or object.

Perceptual mapping has been used in conducting primary market research for the medical and pharmaceutical industries. A perceptual map in this context is a graphical representation of the degree of agreement or association of one or more attributes to be considered with respect to one or more products (e.g., drugs in the case of a pharmaceutical study, medical devices in the case of a medical device study, etc.). Exemplary attributes to be considered with respect to one or more drugs may be safety, cost-effectiveness, tolerability, convenient dosing, etc. For example, in one exemplary primary research study conducted in accordance with this invention, and to be described in detail later, various antibiotic/anti-infective drugs were studied with respect to the attributes of “spectrum of coverage,” “convenient dosing,” “ease to take,” “cost effectiveness,” “safety,” “contribution to resistance,” and “tolerability.” The degree of agreement or association between attributes and products being studied can also be shown in tabular form (as will also be shown in the exemplary antibiotic/anti-infective study).

In order to produce a perceptual map of the physicians responses (e.g., his/her attitudes, opinions and beliefs with respect to the product(s) studied) the survey must include questions that are scalable to capture interval data which represents the level of agreement or association between the attribute and the product(s).

The primary research projects for which this invention has applicability typically begin with a research or business objective that a or plural pharmaceutical companies want to address with primary market research.

As will be described in detail in the discussion to follow the primary research study conducted in accordance with this invention is linked to the core database of information captured by the system 20 (the Transaction Data Model 44). By this technique the subject invention provides the tool to link attitudes, beliefs and opinions to the data captured by the system 20 and available from the Transaction Data Model 44 and the Data Warehouse 48 and tracks changes in the data over time. By virtue of this invention pharmaceutical companies can begin to accurately answer questions heretofore not possible (e.g., “Does promotion have an effect on physicians' perceptions of a product?”, “Do perceptions impact the way physicians treat patients (prescribing intentions)?”, etc.

As discussed above, the system 20 captures data from a network or panel of high volume prescribing primary care physicians (sometimes referred to hereinafter as the “ImpactRx Network”) by using technology to enables its physicians to capture promotion and intended prescribing data. This data is uploaded and converted into data tables that can be easily accessed and queried.

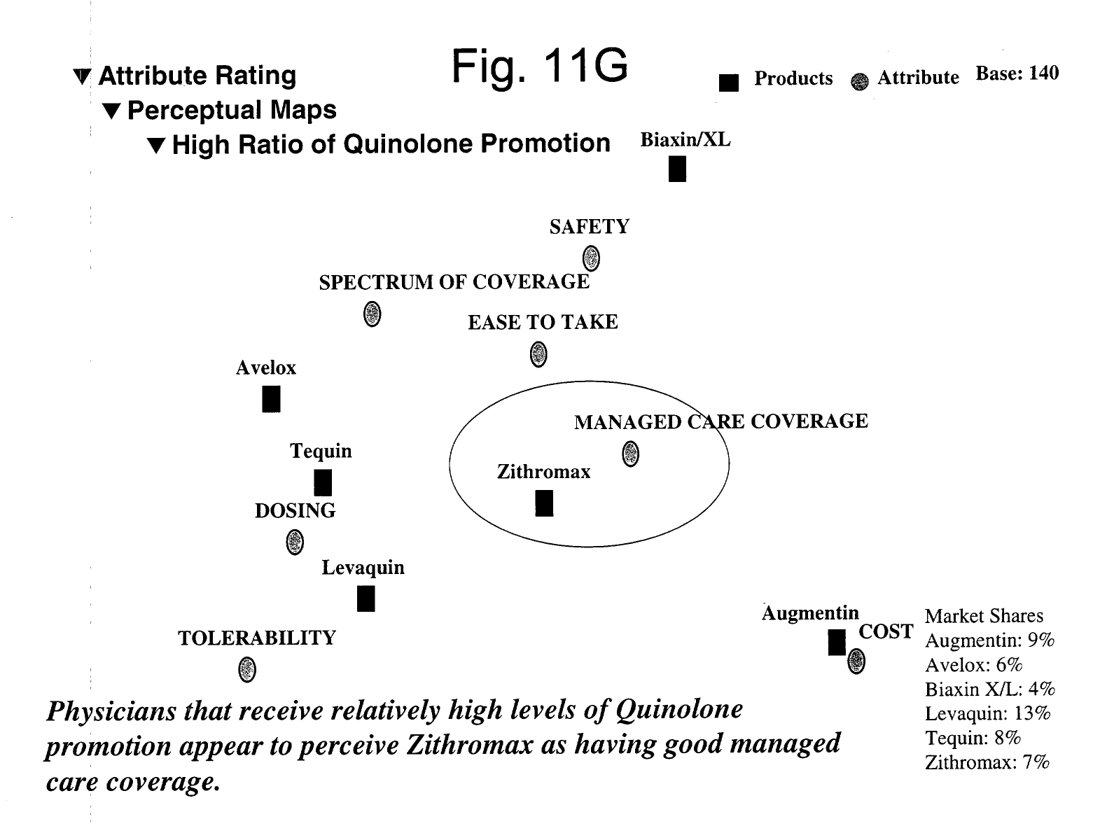

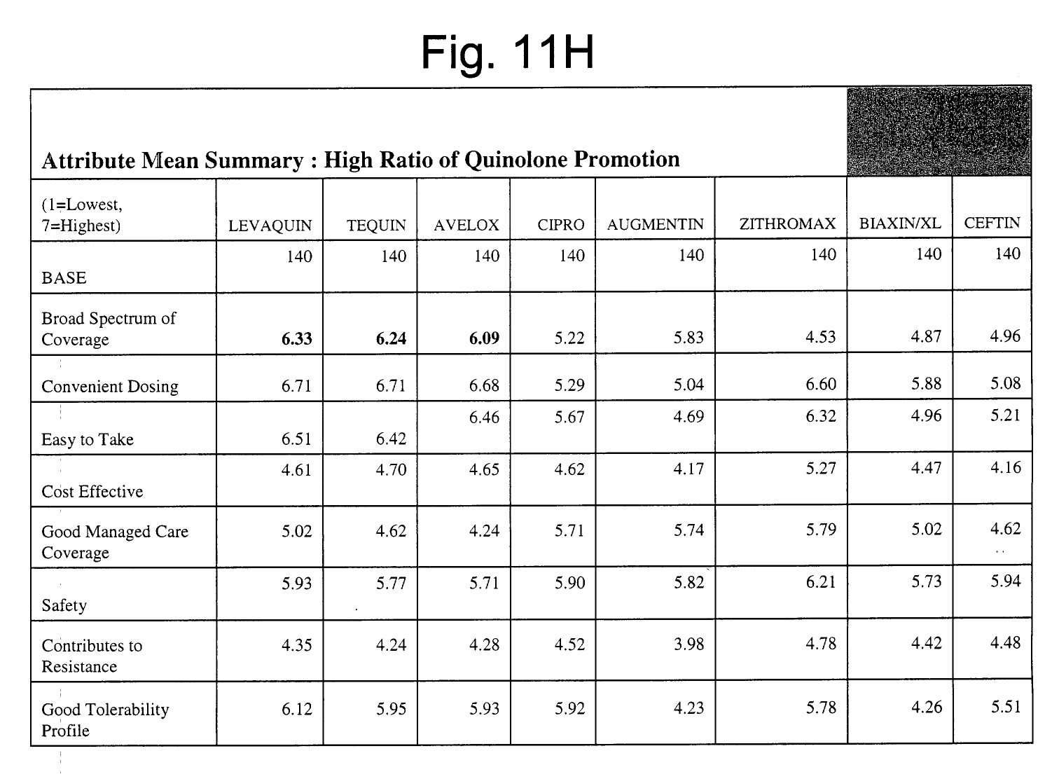

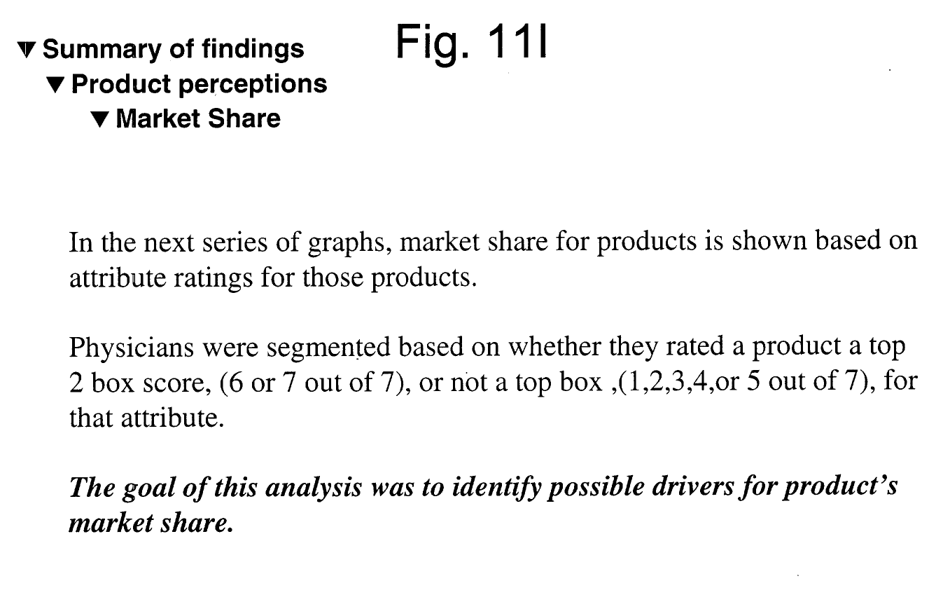

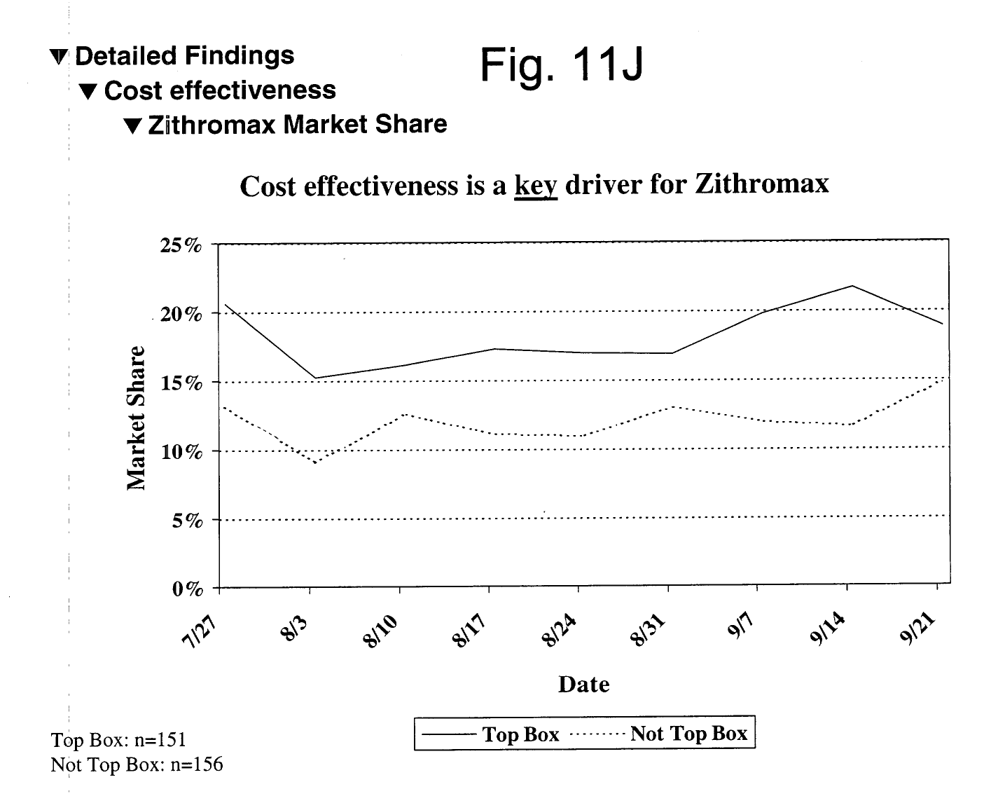

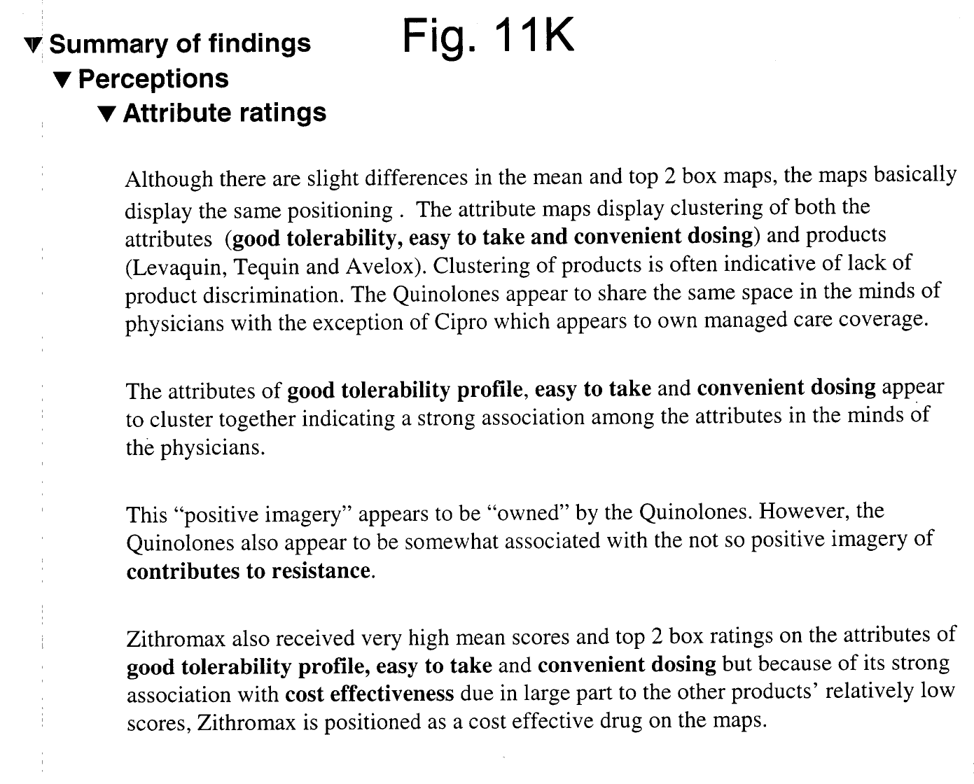

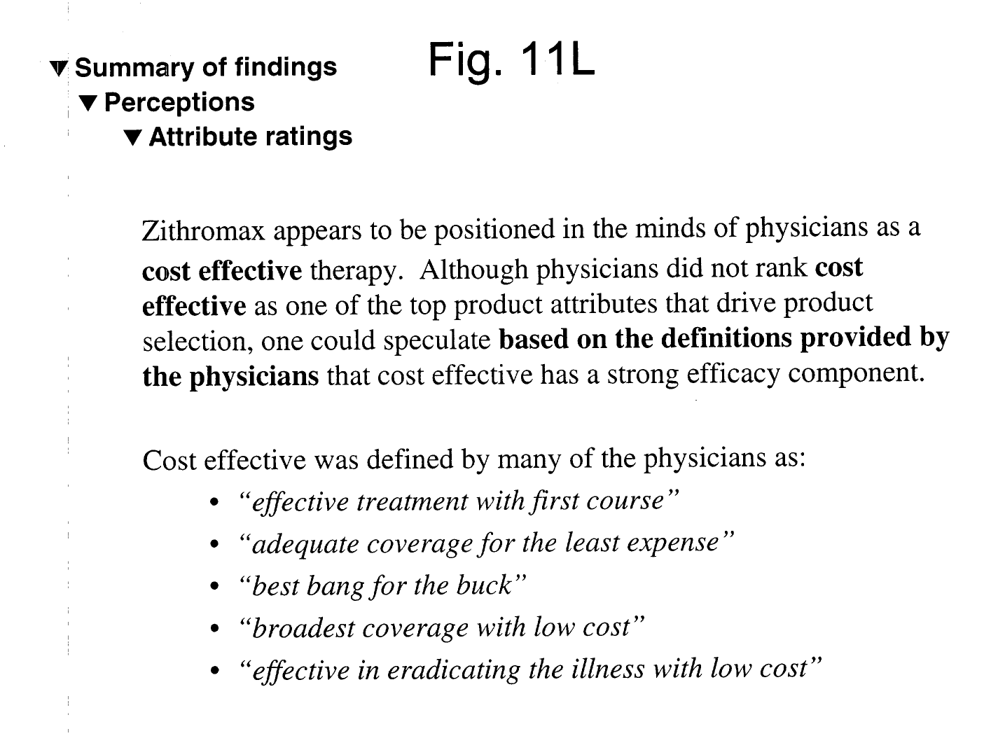

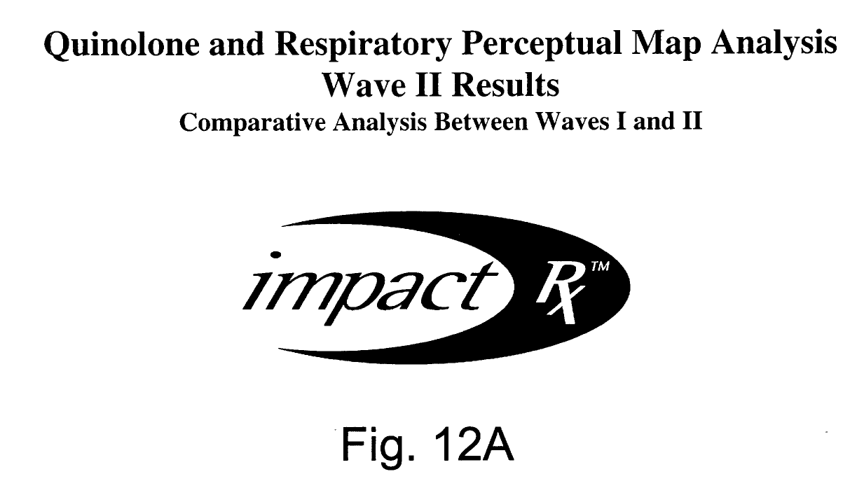

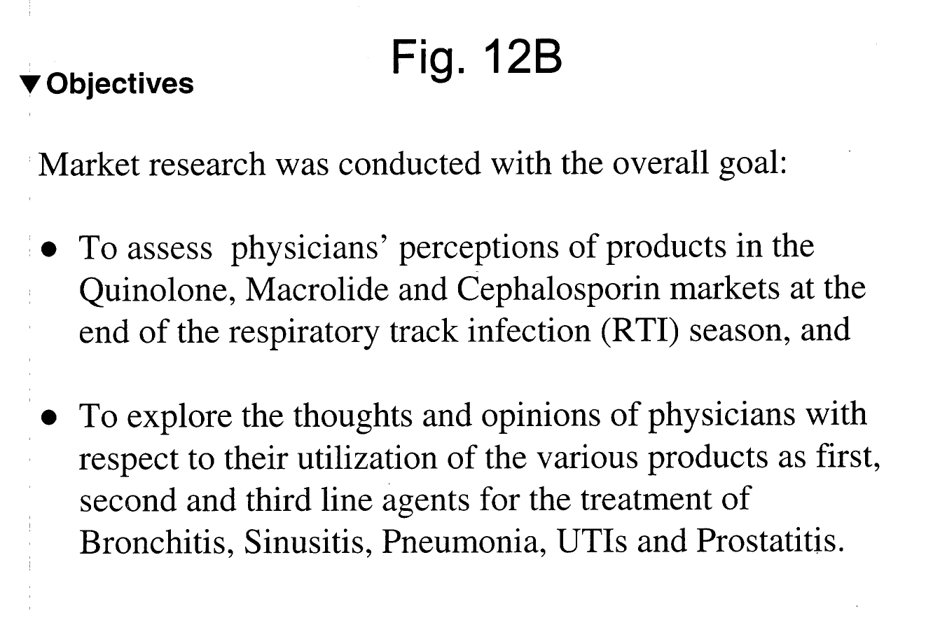

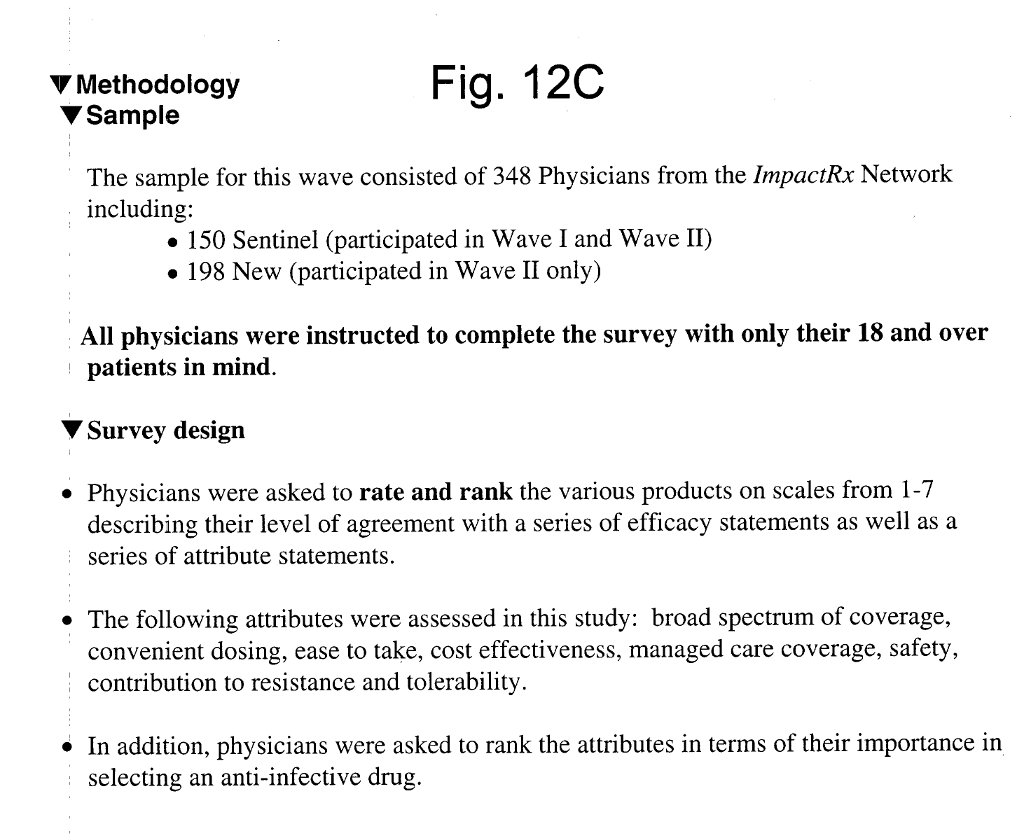

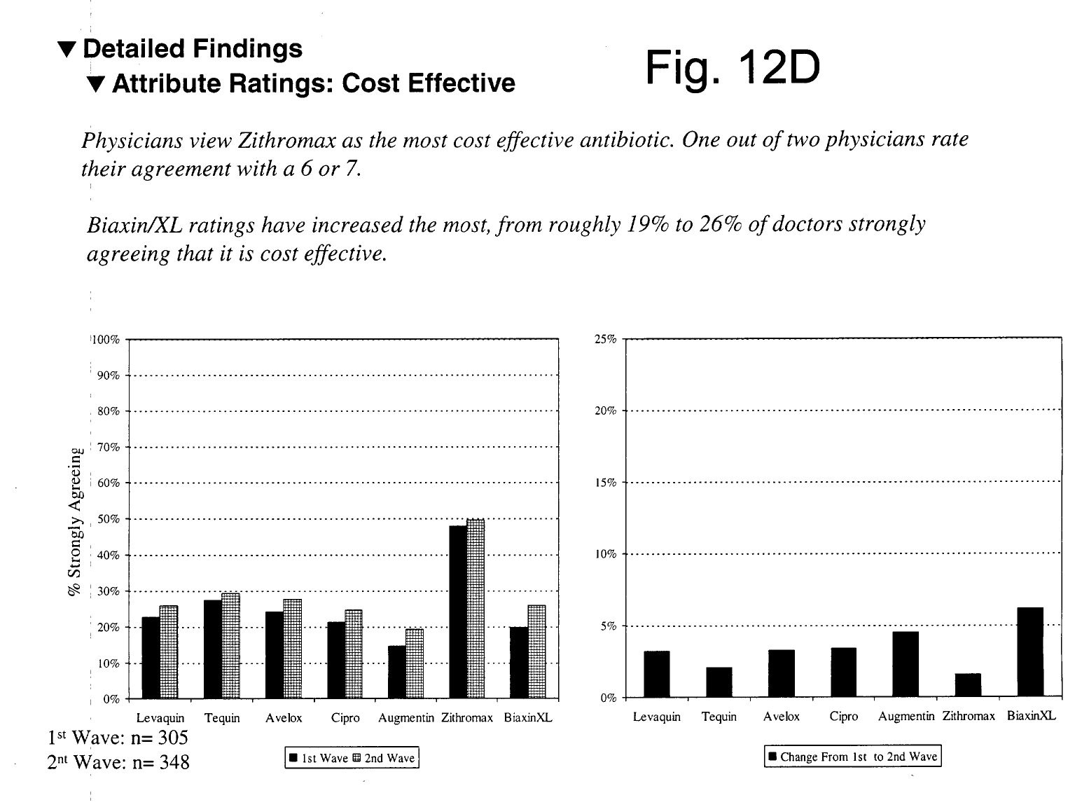

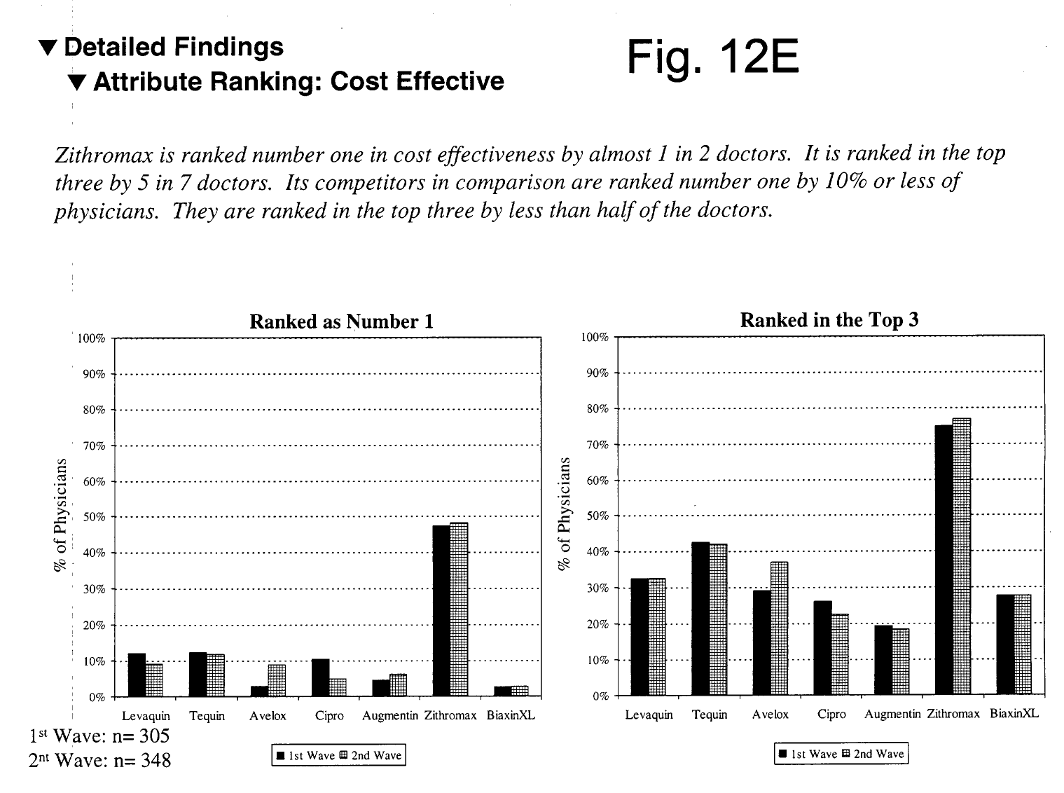

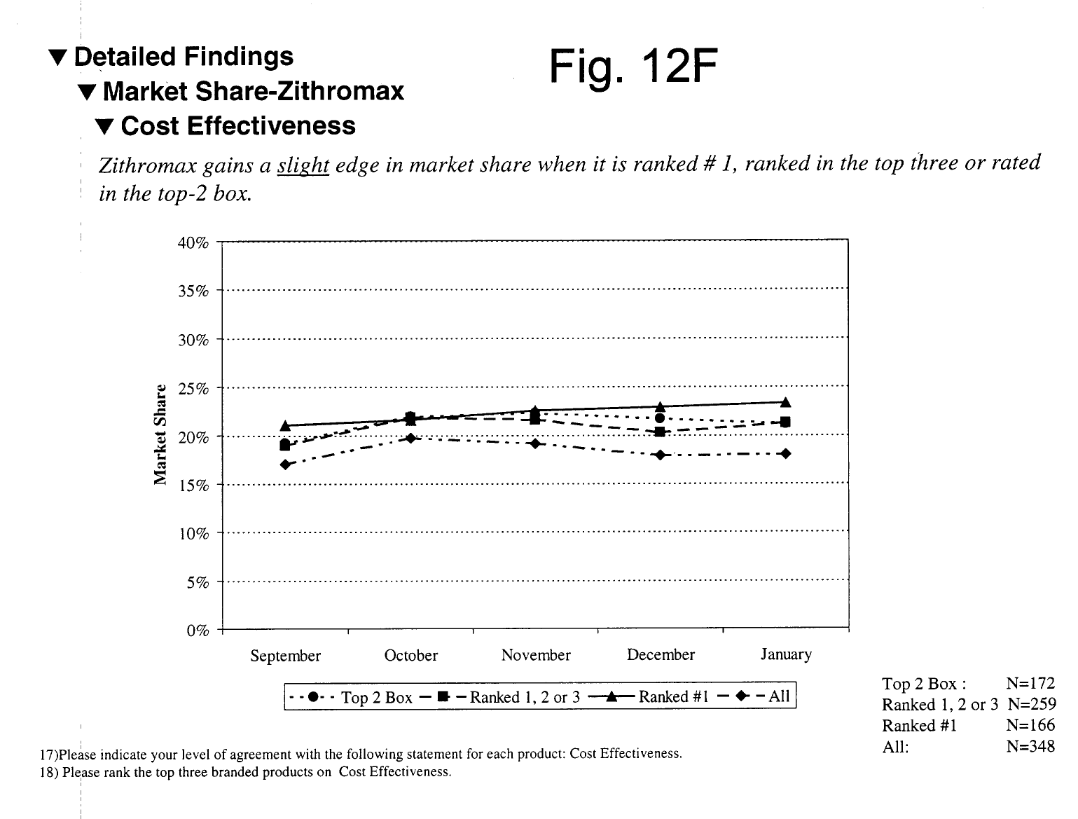

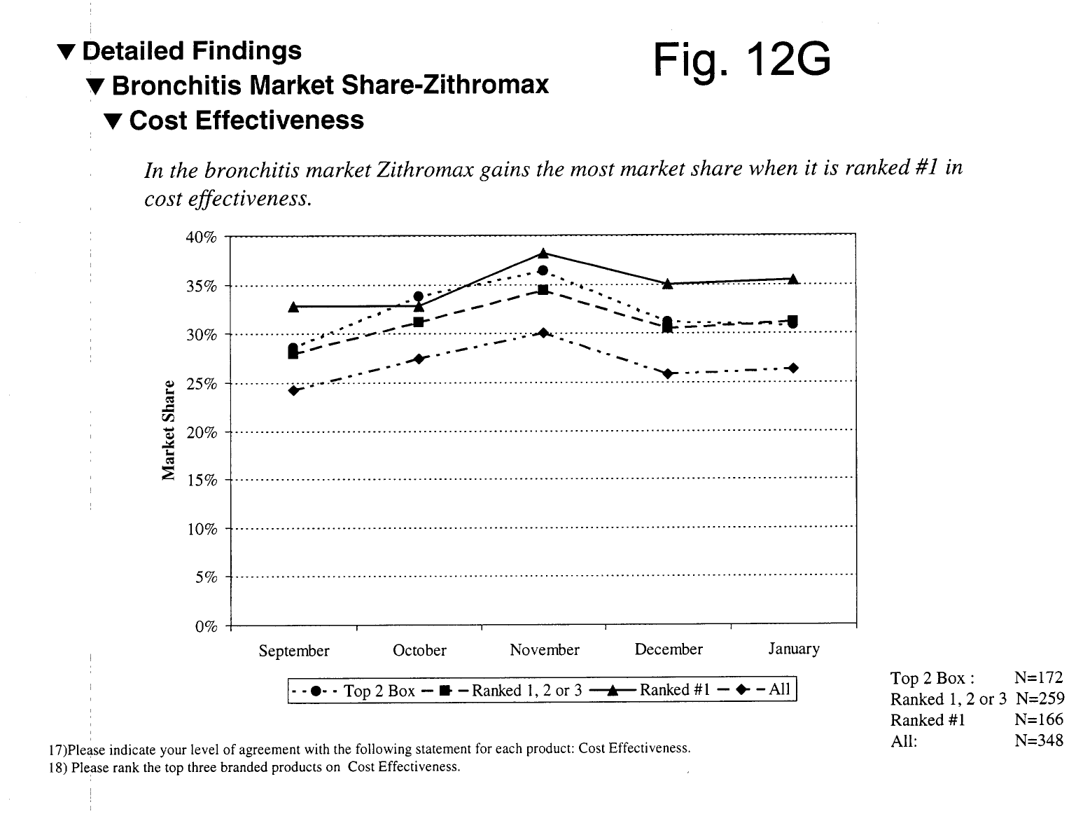

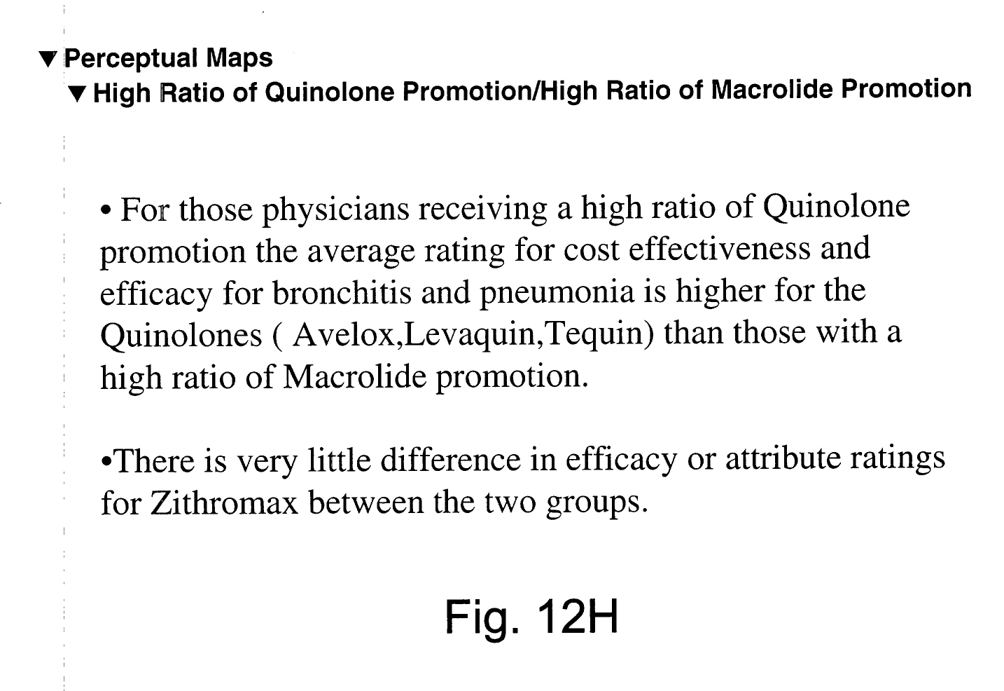

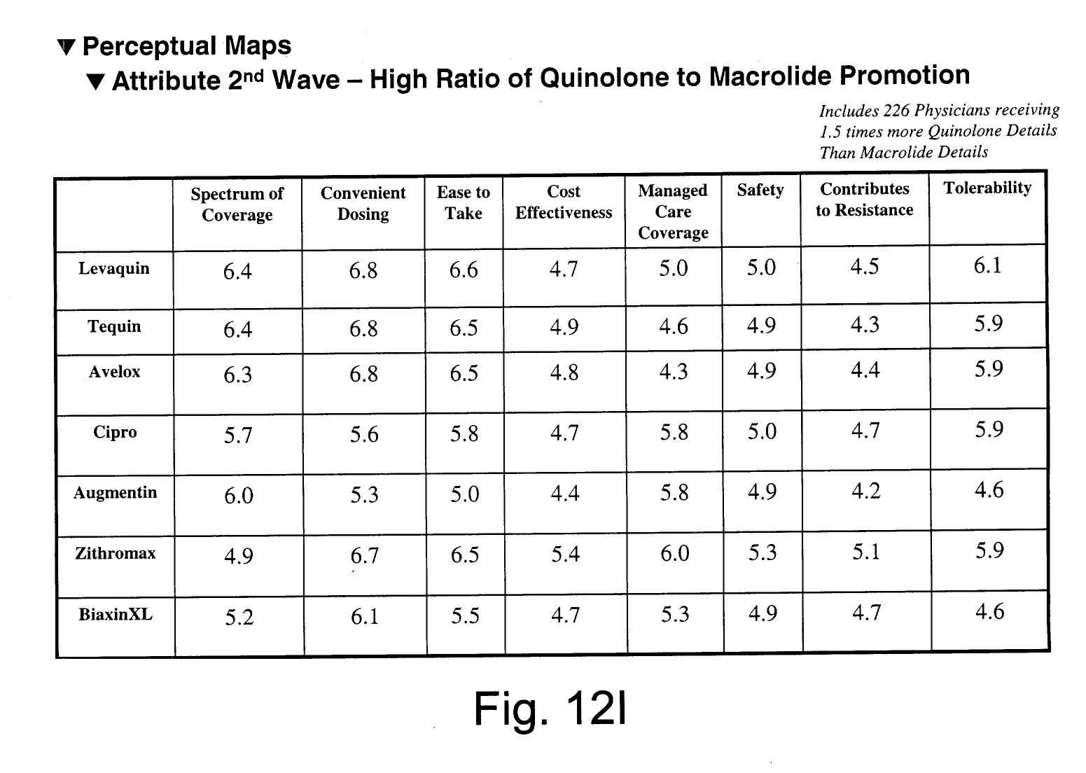

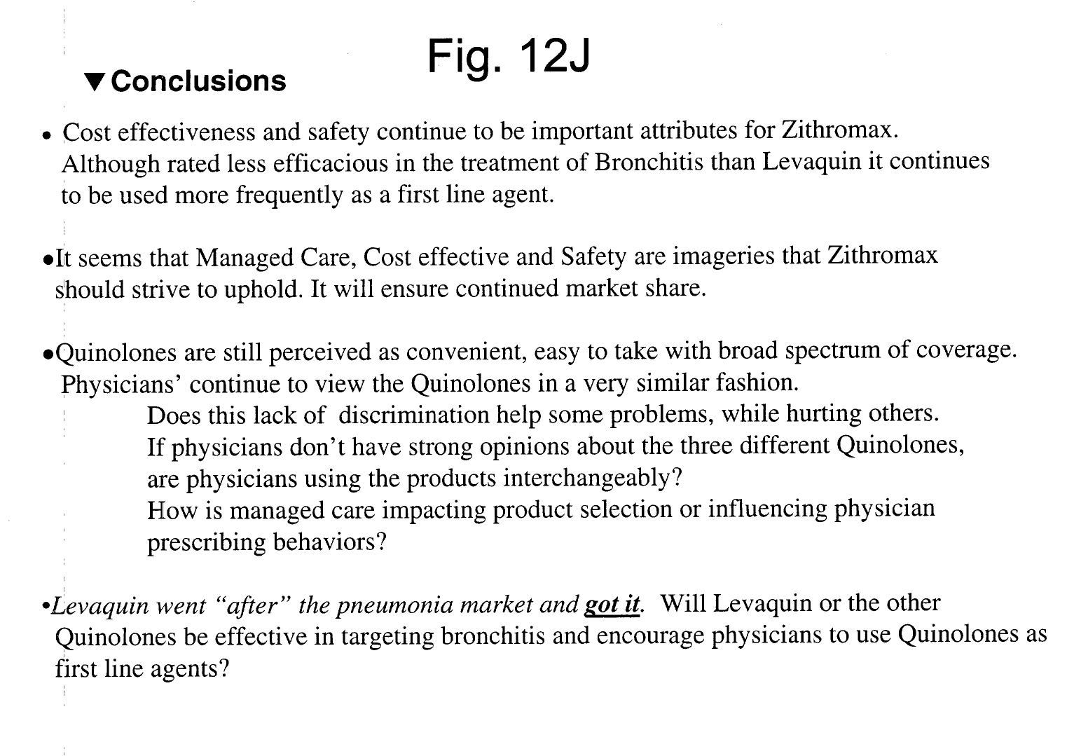

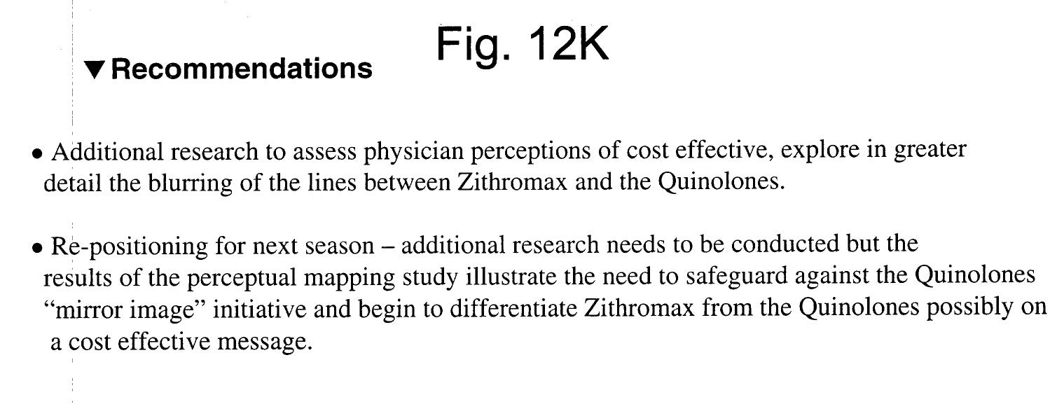

FIG. 9 is a block diagram showing the system 20 used in conjunction with the development and implementation of a primary research study in accordance with one exemplary aspect of this invention. In FIGS. 11A-11L, FIGS. 12A-12K and 13A-13H the results or deliverables of two exemplary primary research studies are shown and will be described in detail later. Suffice it to state at this juncture is that the primary research study whose results are shown in FIGS. 11A-11L represents a first “wave” of a study to assess the perceptions of the major prescription antibiotic/anti-infective products used to treat the conditions of bronchitis, sinusitis, pneumonia, UTIs and prostatitis. The study shown in FIGS. 12A-12K represents a second “wave” of the same study (a repeat of the first wave study conducted at a later time).

As part of the development phase of the primary research study, the Transaction Data Model tables 44 are queried to assess the physician sample available for the research study. This query procedure is shown in FIG. 9 by the block 200 and can be carried out by any terminal, 201, e.g., a lap-top computer. Depending on the study criteria, the query might be as simple as, “Count all compliant (defined as ImpactRx Network physicians who provide data captured on their PDAs 24-1 to 24-N to the system 20 on a weekly basis) physicians” in the database or, as complex as “Identify physicians who write a particular product and have a minimum number of details reported for the product.” In the primary research study shown in FIGS. 11A-11L and FIGS. 12A-12K, which assesses the perceptions of the major prescription products used to treat the conditions of bronchitis, sinusitis, pneumonia, UTIs and prostatitis, the physicians of the panel are screened to identify those physicians who write a sufficient number of prescriptions in the anti-infective or antibiotic field to justify their inclusion into this study. Other inclusion or exclusion criteria can be used in the screening process. The number of physicians meeting these screening criteria is then determined.

Once the database is queried to assure adequate sample (selected physician) availability for the project, the proposal for the study is developed and sent to the client, e.g., pharmaceutical company, for approval. The development of the study, particularly if it is a custom or proprietary study, is accomplished in concert or collaboration with the client. This development process is denoted by the block 202 in FIG. 9 designated “Study Methodology and Proposal Development With Client” and entails developing screening criteria for the physicians of the ImpactRx Network and setting quotas for them. This function is shown by the block 204 designated “Screening Criteria and Quota Setting” and is carried out by the Research Provider, designated by block 206, and the Client, designated by the block 208 working in collaboration. If the primary research study is to be a syndicated one, the screening criteria and quota setting may be accomplished by the Research Provider alone. Even if the study is a syndicated one, input from the pharmaceutical industry and/or specific pharmaceutical companies may be utilized to establish the screening criteria and to set the quotas.

Once the proposal for the study is approved, the sample of physicians in the network or panel is selected from the transaction database of the system 20 and a plan is implemented to recruit those physicians to participate in the study. Recruitment can be achieved through any appropriate means, e.g., email and/or fax invitation, etc. If response rates are low, telephonic contacts can be made to increase the number of physicians in the sample. All of the physicians recruited for the primary research studies conducted in accordance with this invention are part of the ImpactRx Network or panel of physicians from whom data has been collected. The physicians from the ImpactRx Network enter into the research study with an array of longitudinal data variables. This data, which is stored in the transaction data tables, is used to integrate the promotion, intended prescribing behavior and patient treatment data with the results of the primary market research. At the same time that recruitment is taking place, the survey questionnaire is developed.

The development of the survey questionnaire or “instrument” is designated by the block 210 entitled “Research Instrument Development,” once the screening criteria and quota setting has been achieved. Questionnaires are developed, as designated by the block 212 entitled “Develop Research Instrument,” by market researchers in the Research Provider's market research team. This is preferably accomplished using the best known practices for survey design and development. The market research group may work in conjunction with pharmaceutical clients to develop the research instruments and also may conduct secondary research to define the research instrument. This secondary research is shown by the block 214 designated “Secondary Research” and can consist of reference to any secondary sources of relevant information, e.g., pharmaceutical company website and/or other Internet sites, industry “Pink Sheets,” industry journals, etc. Another secondary research source that may be utilized is that of existing research questions, response sets, scales, etc. of the Research Provider 206. These secondary sources are designated by the block 216 entitled “Existing Research.”

Once the research instrument is defined and approved by the Client 208, the Research Provider 206 conducts at least one pretest with the physicians who will participate in the study. This is done to ensure proper flow and wording of each of the questions, to correct any “bugs,” etc. The pretest procedure is designated by the block 218 entitled “Conduct Pretest.” Depending upon the results of the pretest, the research instrument or survey can be modified, as designated by the block 220 entitled “Modify Research Instrument” or can be used as tested to complete the preparation of the survey. If necessary or deemed appropriate resort to further Secondary Research 214 may be carried out during the modification of the research. Once the pretest(s) is/are completed and any modification made to the research instrument, the research instrument is then finalized as shown by the block 222 entitled “Prepare Survey” . It is now ready to be administered. For surveys to be administered to the selected physicians of the ImpactRx Network via the Internet, there is an additional step (not shown) in FIG. 9 of programming the survey into a software program for residence on a server of the system 20. Once this step is complete, the survey is placed in the field for use by the physicians taking part in the study, as shown by the box 224 entitled “Field Survey.” In particular, the survey is made available to physicians who have been identified and recruited from the network to participate in the study. Not all of the physicians who have been identified and asked to participate in the study agree to do so. The recruited physicians who “opt-in” (agree to be participants) for the study thus constitute a subset of the entire ImpactRx Network and are represented by the block 228 designated as “Selected Network Physicians.” In the exemplary first wave study of FIGS. 11A-11L (to be discussed later) three hundred seven physicians of the recruited physicians opted-in to be study participants, whereas in the second wave study of FIGS. 12A-12K three hundred forty-eight physicians from those recruited opted-in, with one hundred fifty of those physicians having participated in both wave studies (such common physicians being referred to as “Sentinel” physicians, and with one hundred ninety-eight being “New” physicians (only having participated in the second wave study).

In the case of qualitative studies or quantitative studies conducted over the telephone or in-person, the interviews can be conducted as soon as the research instrument is approved by the client. The research instrument can also be placed into the field by mail, with the results collected by mail.

One particularly preferred way of conducting the study is via the Internet. Data from the internet surveys is collected and stored in a separate server. Once all of the data is captured (study quota is met) the survey is removed from the website and the data is converted into access tables for easy access. It should be pointed out at this juncture that the primary research study need not be in the form of a survey. Rather it can be achieved through any technique, e.g., in-depth interviews conducted in person or over the Internet, focus groups conducted in-person or over the Internet, and interactive voice response telephone surveys, providing that such a study is conducted of physicians in the network and by making reference to the data collected from them (i.e., the data in the Transaction Data Model 44).

In FIGS. 10A-10C three exemplary questions from the primary research study of FIGS. 11A-11L are shown for Internet administration (delivery and collection). The physicians participating in the study can provide their answers to the questions by either clicking on the “radio buttons,” “check boxes,” or the like for questions like that of FIG. 10A or by actually typing their answers in boxes provided for the relevant data like the questions of FIGS. 10B and 10C. As will be described later some of the questions, e.g., the question of FIG. 10A, can be a multi-part question assessing a certain attribute for various products, wherein the respondent (the physician to whom the survey is directed) rates the product for that attribute on a scale. In the exemplary embodiment shown the scale is from 1 to 7, with a rating of 1 denoting “strong” disagreement and with a rating of 7 denoting “strong” agreement.

Once the survey has been administered and responses received from the Selected Network Physicians 228, an analysis of the survey results is conducted as represented by the block 226 designated “Analysis of Survey Results.” The data collected by the system 20 as described heretofore, e.g., the data representing the promotional activities and the prescribing activities of the ImpactRx Network of physicians, as captured by their PDAs 24-1 to 24-N, is stored in the transaction tables of the Transaction Data Model 44 and is queried for integrated data analysis with the survey data as represented by the block 200 designated “Query Transaction Data Model.”

The first step of the integrated analysis is to create a table to use in access queries to easily identify physicians who participated in the study. This list or table of physician identification (“I.D.s”) allows the Research Provider's analyst(s) to quickly and easily link physician response to survey data to the data captured in the transaction tables of the Transaction Data Model 44. This linking procedure allows the analyst(s) to quickly recalculate key metrics, like those described heretofore using the system 20, and apply these same recalculated metrics to the survey analysis. By identifying and creating these identification lists, linked analysis can be completed in a very efficient manner.

The analysis of the survey data is initially effected via simple marginal or cross tab analysis. Each question is analyzed by displaying the number or percent of responses for each response for close-ended responses. All open-ended questions are coded and cleaned. Once this has been completed, the analyst begins the process of integrating the data previously captured from the physicians via their PDAs 24-1 to 24-N (e.g., the promotion activities, intended prescribing activities, etc.) into the analysis of the survey data as is represented by the block 230 designated “Integrated Analysis.” The analyst(s) review(s) the results of key survey questions and then determine(s) a strategy to segment physicians based on the responses. This process requires a thorough understanding of the Client's business issue(s) or the topic that the Research Provider is seeking to explore. The survey data is analyzed to identify meaningful physician cohorts (segments of the Selected Physicians 226) and can be analyzed for differences among the various cohorts. For example, physicians in the study of FIGS. 11A-11L who rated a particular drug, e.g., Zithromax, high on a particular attribute, e.g., ‘cost-effectiveness,” can be segmented into a cohort (a subset) by their I.D. numbers. The database of the Transaction Data Model 44 can then be queried to look for specific data elements or variables of interest, e.g., the physician's percentage of prescriptions for Zithromax (sometimes referred to as “market share”). Another cohort can be studied, e.g., those physicians who didn't rate Zithromax high on the attribute of cost effectiveness, by querying the Transaction Data Model 44 to determine the market share of the physicians in that cohort. Other data, e.g., intended market share, sample usage, promotion, demographic, patient insurance type, etc., can be calculated for each of the cohorts of physicians by querying the Transaction Data Model 44 for the desired data contained in it, e.g., the level of promotion given to the physicians in the cohort, etc. Once this is completed the analyst(s) review(s) the data for interesting and/or significant findings, e.g., findings regarding the effectiveness of pharmaceutical company promotion to sway or influence physician's attitudes regarding the cost-effectiveness of Zithromax.

These findings can be used in visual maps, graphs or tables forming a part of the report(s) or deliverables, represented by block 232 designated “Output Report(s),” provided by the Research Provider to the Client.” For example, physician segments can identified based on the data in the Transaction Data Model 44 and the data can be then analyzed for differences and/or similarities and recalculated for the various segments. Once this step is complete the analyst(s) review(s) the data to look for interesting and/or significant findings to graph or display in visual maps or tables forming the Output Report(s) 232.

The Integrated Analysis procedure as carried out in block 230 may include an optional step of segmenting the Selected Physicians 226 based on previously stored data (e.g., their market share for a particular or group of products, promotion for a particular product or group of products, etc.) and analyzing survey data across these segments for differences and/or similarities using multi-dimensional scaling techniques. This optional step is typically completed for perceptual mapping or attribute tracking studies.

The Output Report(s) is(are) compiled from the results of the Integrated Analysis procedure and any graphs, maps, charts, tables, etc. generated during that procedure. The final report(s) can be of any form desired by the Client 208 and/or the Research Provider 206. The Output Report 232 may be a perceptual map report(s), such as represented by the block 234 designated “Client Perceptual Map Report(s)” and/or may be other qualitative and/or quantitative reports, such as represented by the block 236 designated “Other Qualitative/Quantitative Report(s).” Such other reports may be in the form of Point Vector Maps, etc. The reports may also contain tables, graphs and textual materials. A typical Output Report(s) may include the following exemplary sections: an executive summary, detailed findings, conclusions and recommendations. These reports are fully integrated and have detailed summaries of differences observed both between and within the segments. The report may be provided in hard copy or electronic form, e.g., a series or group of PowerPoint slides. In FIGS. 11A-11L there are shown representative exemplary slides of an Output Report in PowerPoint slide format for an exemplary syndicated perceptual map study entitled “Quinolone and Respiratory Perceptual Map Overview.” A discussion of some of the slides of that study will be provided later.

Depending on the nature of the study, physicians may be researched with the same survey instrument at a later point in time (a subsequent “wave”) to assess the impact of promotion on behavior. Multi-wave studies can provide the client with a great degree of flexibility. An example of a multi-wave perceptual map study is the second wave of the study of FIGS. 11A-11L. The Output Report of this second wave study is also in the form of a series of PowerPoint slides shown in FIGS. 12A-12K. A discussion of some of the slides of that study will also be provided later.

The wave studies may or may not include physicians from the initial research group, i.e., the Selected Physicians 226, so long as they are from the ImpactRx Network. Depending on the methodology outlined by the Client or the Research Provider, physicians may or may not be encouraged to participate in subsequent waves of research.

Subsequent waves include the following options for data analysis purposes: only those physicians who are in the ImpactRx Network but did not participate in the first or previous wave(s) study(ies) (referred to as “New” physicians), physicians who have participated in all previous waves of the research study (referred to as “Sentinel” physicians), and a combination of New and Sentinel physicians.

The advantage of researching the same group of physicians from the ImpactRx Network is the ability to track longitudinally the amount and types of promotion that the physicians were exposed to as well as their behavior (intended prescribing behavior). Physicians who have taken part in the first wave of research can be identified and flagged for recruitment for subsequent waves. Once the decision is made to conduct the second or subsequent wave of research, physicians are made aware of the time period to take the survey on-line and the information is captured, stored and then converted in the same manner for all Internet-based surveys. The initial wave should include a sample of sufficient size for meaningful results, e.g., at least 200 physicians, with the screening criteria being established by collaboration between the Research Provider and the Client.

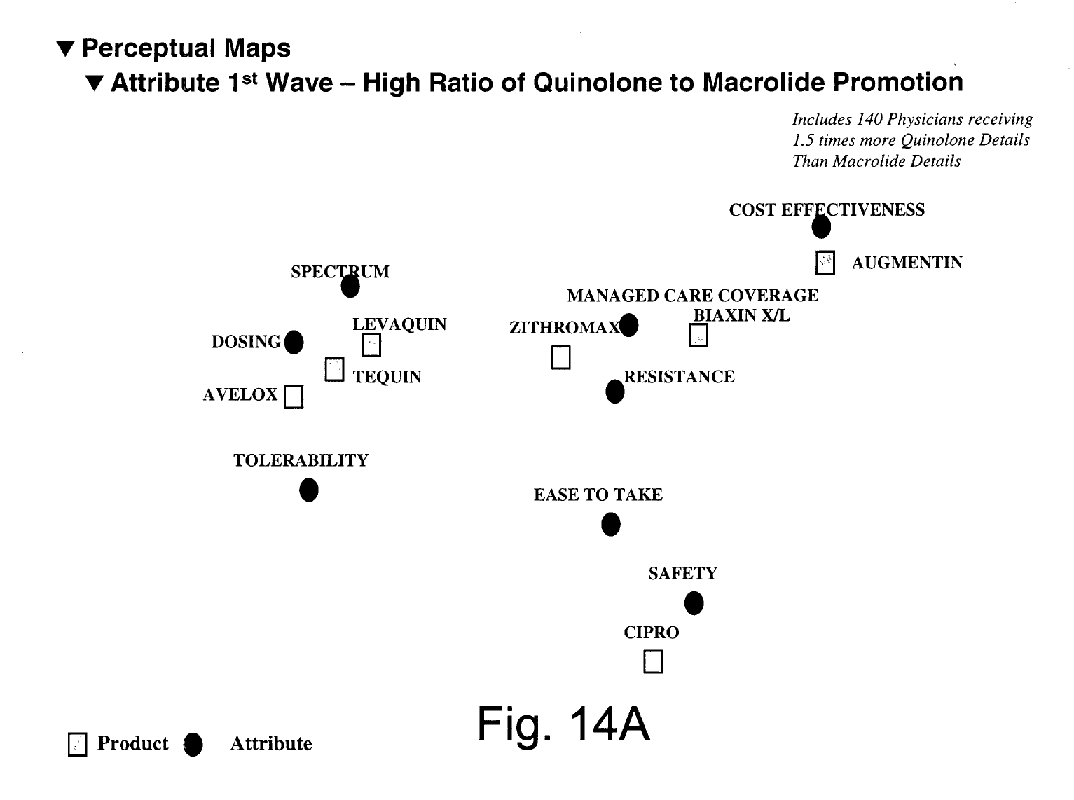

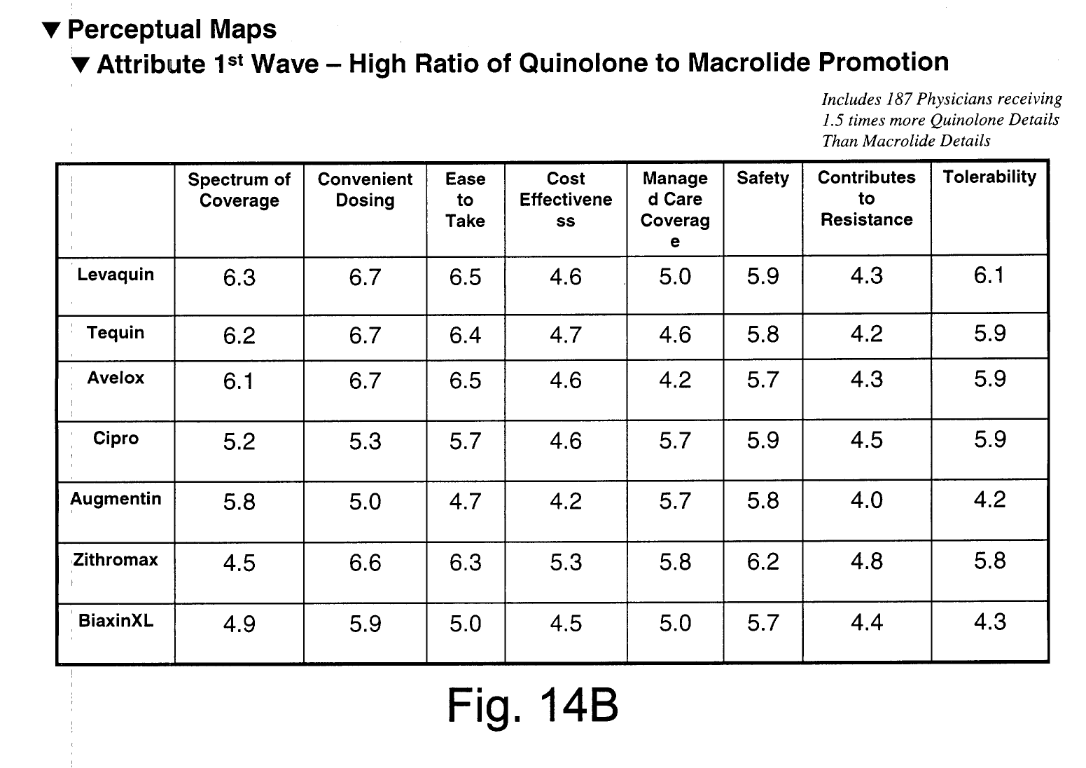

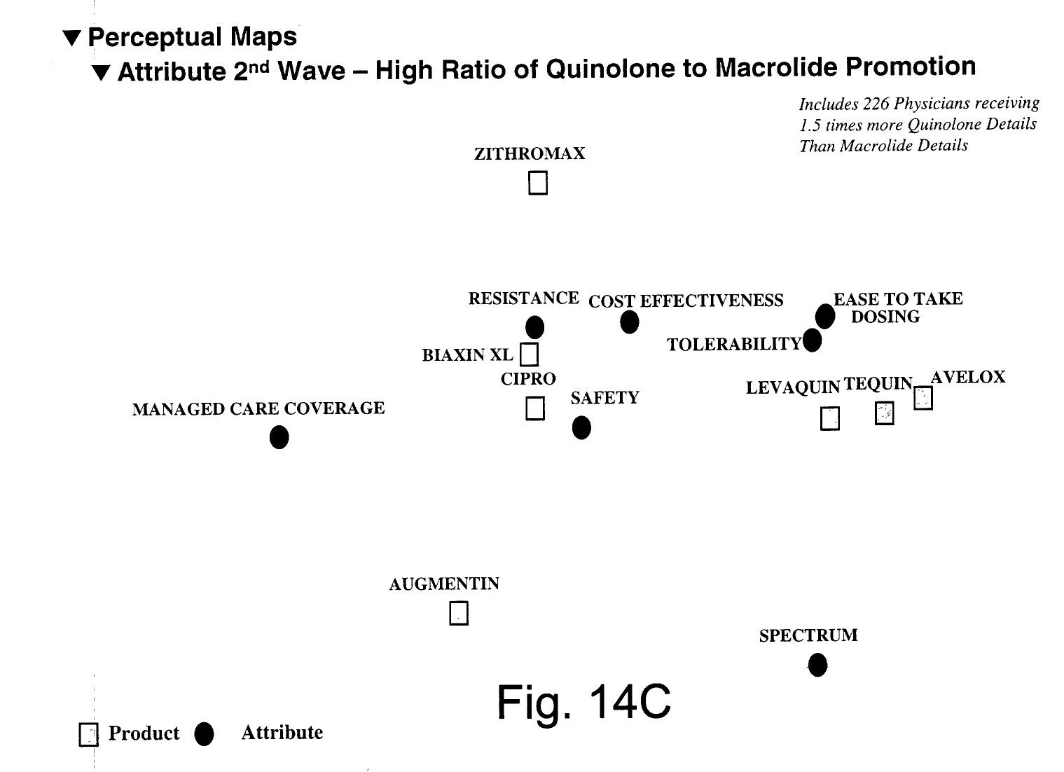

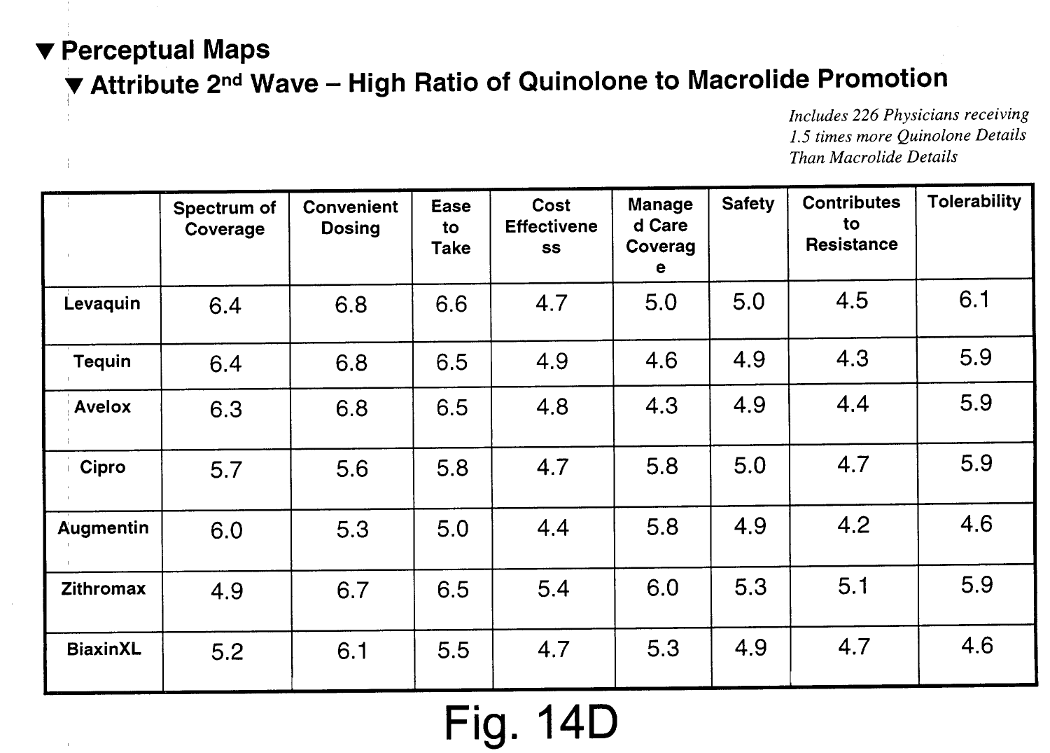

The same data analysis process or procedure is followed to analyze the second or subsequent wave data, with the added step of integrating the results of the first wave or subsequent waves of research with the most current wave of research. The integration and analysis of multiple waves of research is preferably supervised by senior market researchers within the market research department of the Research Provider. All of the deliverables that are developed in the first or initial waves are developed for the current wave study and compared. Written analysis is provided wherever appropriate to explain or highlight differences or similarities across the waves of research. In FIGS. 14A-14D there are shown a series of representative exemplary PowerPoint slides of perceptual maps and tables showing the differences in one attribute, e.g., “High Ratio of Quinolone to Macrolide Promotion” of the first and second wave studies of FIGS. 11 and 12. A discussion of some of the slides of that study will be provided later.

The final report is delivered, e.g., sent, to the Client. If desired, follow-up ad hoc analysis can be conducted following the receipt of the deliverable to explore additional tie-backs to the ImpactRx Network data collected by system 20. This analysis is highly customized and depending on the complexity of the request, may fall out of scope for standard follow-up for a perceptual mapping study. As should be appreciated by those skilled in the art, the methodology described above for conducting the primary research study is merely exemplary of various well known research methodologies that can used by the Research Provider in accordance with this invention. Among those methodologies are: the heretofore mentioned multidimensional scaling (MDS) perceptual maps, as well as attribute tracking studies (simple mean and top 2 box analysis with statistical validation), message tracking (verbatim analysis), sales force effectiveness of quality analysis (simple mean analysis to more complex perceptual mapping studies with statistical modeling and validation), qualitative interviews (standard qualitative reports), market impact studies (standard cross tab analysis with statistical modeling and validation), market assessment studies (standard cross tab analysis with statistical modeling and validation), etc., providing that all of the foregoing are linked and integrated with the data collected by the system 20. Among the statistical methodologies that can be employed in the primary research study are: conjoint and discrete choice modeling, regression analysis (to explain and/or predict), simple, multiple, logistic regression, factor analysis, latent class analysis, MANOVA, ANOVA, Chi square and t-tests for validation analysis.

Turning now to FIGS. 10A-10C a description of exemplary questions for the exemplary syndicated primary research study involving antibiotics/anti-infectives will now be described. A primary research study typically involves a relatively large number of questions. Initial questions are typically of a demographic type, e.g., the State in which the physician has his/her practice, the number of patients seen in an average month, the age groups of the physician's patient, etc. Other questions delve into the specifics of the study, e.g., the physician's level of agreement with various attributes for each of the drugs in the study. In the exemplary study of FIGS. 11A-11L, one of the study questions is the level of the physician's agreement with the attribute of “cost effectiveness.” This question is shown in FIG. 10A. As can be seen therein, the response set is displayed in tabular form, with the list of drugs of the study, e.g., Levaquin, Tequin, Avelox, Cipro, Augmentin, Zithromax, Biaxin/XL, Ceftin, Cefzil and Omnicef, listed in the first column. Seven ratings columns representing a level of agreement from 1 to 7 are located to the right of the column of drugs. Each of the seven ratings columns includes a radio button or check box to be selected by the physician to indicate his/her level of agreement for each of the drugs listed, with a selection of a rating of “1” indicating the strongest disagreement and with a rating of “7” indicating the strongest agreement. There are two other columns to the right of the numeric columns. Those represent an answer of “don't know” (“DK”) and “not applicable” (“N/A”).

In FIG. 10B there is shown a question for the physician to insert his/her list of the top three products for cost effectiveness in an associated box. The names may be typed into these boxes by the physician or may be selected from a drop down list (not shown).

In FIG. 10C there is shown an open ended question wherein the physician has to enter or type in his/her definition of the term “cost effective.” The survey includes other questions relating to other attributes to be rated for the drugs listed, e.g., “broad spectrum of coverage,” “convenient dosing,” “easy to take,” “good managed care coverage,” “safety,” “contributes to resistance,” and “good tolerability profile.”

Turning now to FIGS. 11A-11L a description of some of the slides of the Output Report(s) 232/234 for the syndicated primary research study using the question of FIGS. 10A-10C and other questions as described above will now be given. In this case, the Output Report 234 is in the form of a series of slides, e.g., PowerPoint slides, and is entitled “Quinolone and Respiratory Perceptual Map Overview.

FIG. 11A represents the cover slide or page of the output report. FIG. 11B describes the objective of the study and, the sample physicians (e.g., three hundred seven physicians from the ImpactRx Network agreed to participate to provide information regarding their 18 and over patients). In addition, the survey design is described. FIG. 11C describes the methodology used in the study, e.g., correspondence analysis used to create the perceptual maps. In addition, the slide of FIG. 11C describes how the perceptual maps can be interpreted. FIG. 11D shows a perceptual map of the results of the study. FIG. 11E shows results of the study in the form of a bar chart. FIG. 11F is a summary of the findings regarding the attribute rating for perceptual maps, and in particular the evaluation of the effect of promotion on perceptions and behavior. FIG. 11G displays the perceptual map for a High Ratio of Quinolone to Macrolide Promotion Physicians. FIG. 11H is a table showing the ratings given by the physicians in the study for the various attributes for the various drugs. FIG. 11I is a summary of findings regarding the market share. FIG. 11J is a graph of the detailed findings showing cost effectiveness is a key driver for Zithromax market share. FIG. 11K is a Summary of Findings on perceptions regarding attribute ratings. FIG. 11L is a further discussion of the Summary of Findings regarding perceptions on attribute ratings.

Turning now to FIGS. 12A-12K a description of some of the slides of the report for the second wave of the syndicated primary research study of FIGS. 11A-11L will now be given. The Output Report for this study is also in the form of a series of slides, e.g., PowerPoint slides, and is entitled “Quinolone and Respiratory Perceptual Map Analysis Wave II Results.”

FIG. 12A is the cover slide of the report for the Wave II Results. FIG. 12B is a slide indicating the objective of the study. FIG. 12C is a slide describing the methodology used in the study, e.g., that the sample for this Wave consisted of 348 physicians from the ImpactRx Network, including one hundred fifty Sentinel physicians and one hundred ninety-eight New physicians. The survey design is also described in FIG. 12C. FIG. 12D is a slide of the detailed findings regarding attribute ratings for cost effectiveness. This slide includes two bar graphs, with the right-most graph representing changes from the first and second wave. FIG. 12E is a slide including another pair of graphs of detailed findings showing the attribute ranking for cost effectiveness wherein one graph shows the various drugs ranked as number one and the other graph represents the various drugs in the top three. FIG. 12F is a slide of the detailed findings showing the market share of Zithromax for the attribute cost effectiveness. FIG. 12G is a slide of further detailed findings showing the bronchitis market share for Zithromax for the attribute cost effectiveness. FIG. 12H is a slide including a discussion of the perceptual maps regarding High Ratio of Quinolone Promotion to High Ratio of Macrolide Promotion. FIG. 12I is a slide in tabular form of the attributes of the second wave-High Ratio of Quinolone to Macrolide Promotion. FIG. 12J is a slide including the conclusions of the study. FIG. 12K is a slide including recommendations of the Research Provider based on the study.

FIGS. 14A-14D represent four slides of the report for the second wave of the syndicated primary research study of FIGS. 11A-11L to show the differences between the first wave and second wave results. To that end, FIG. 14A is a slide that shows the results of the study in a perceptual map format for the attribute of the first wave-High Ratio of Quinolone to Macrolide Promotion. FIG. 14C is a slide of a corresponding perceptual map for the second wave. FIG. 14B is a slide of a table for the data presented in FIG. 14A, whereas FIG. 14D is a slide of a table for the data presented in FIG. 14C.

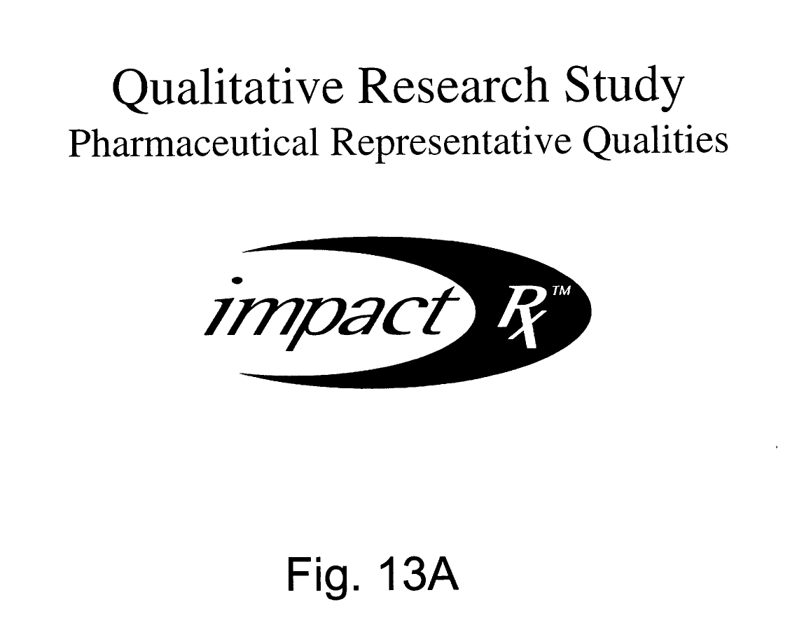

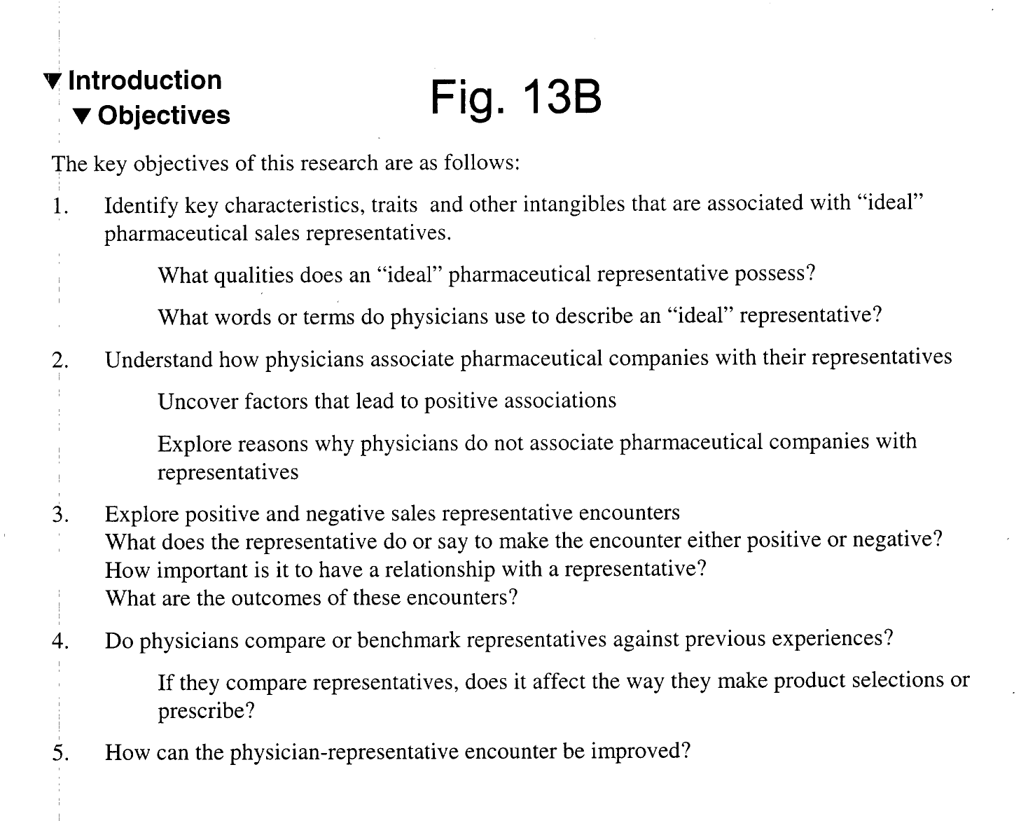

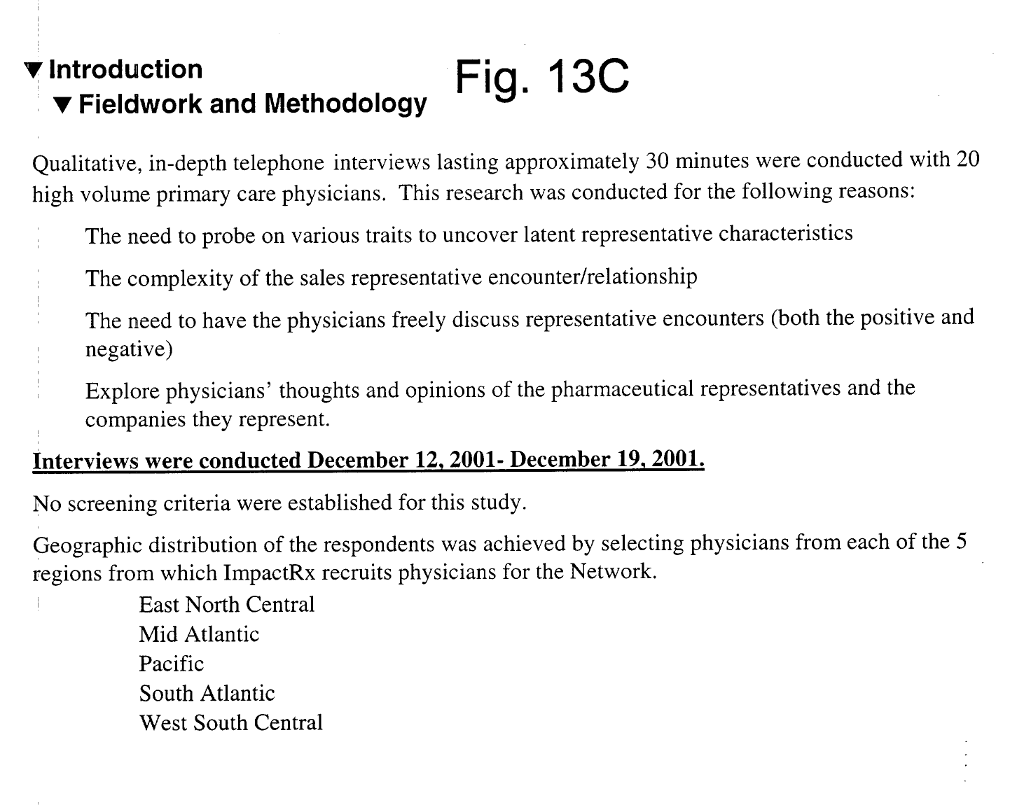

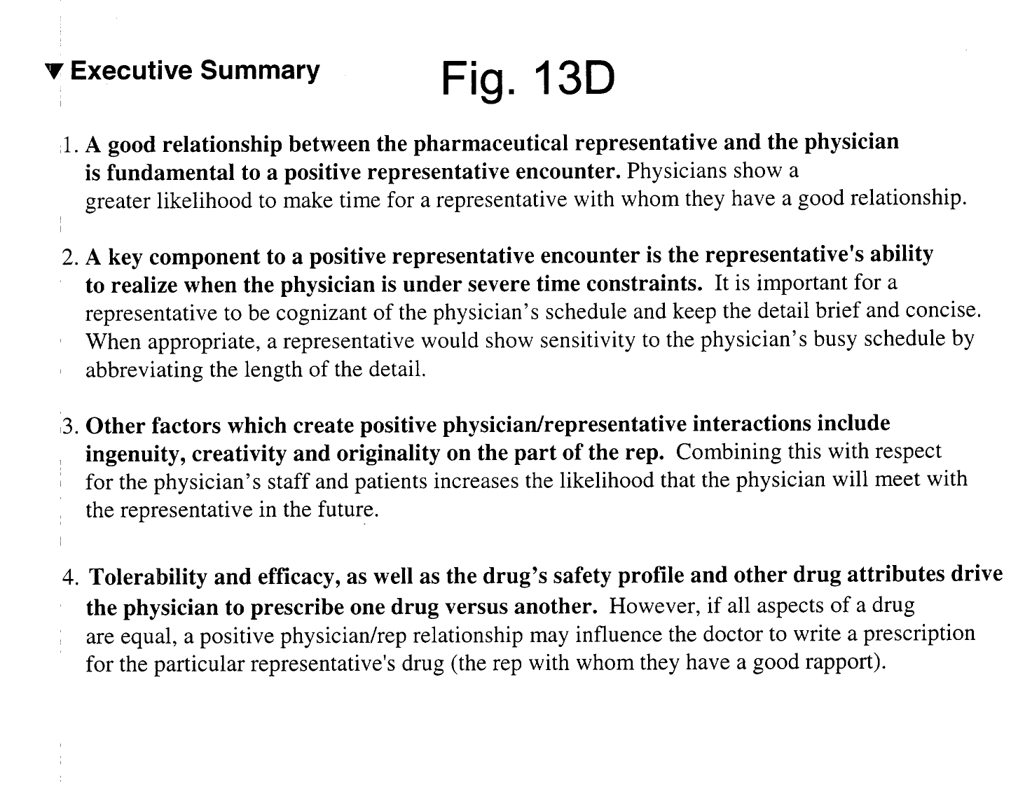

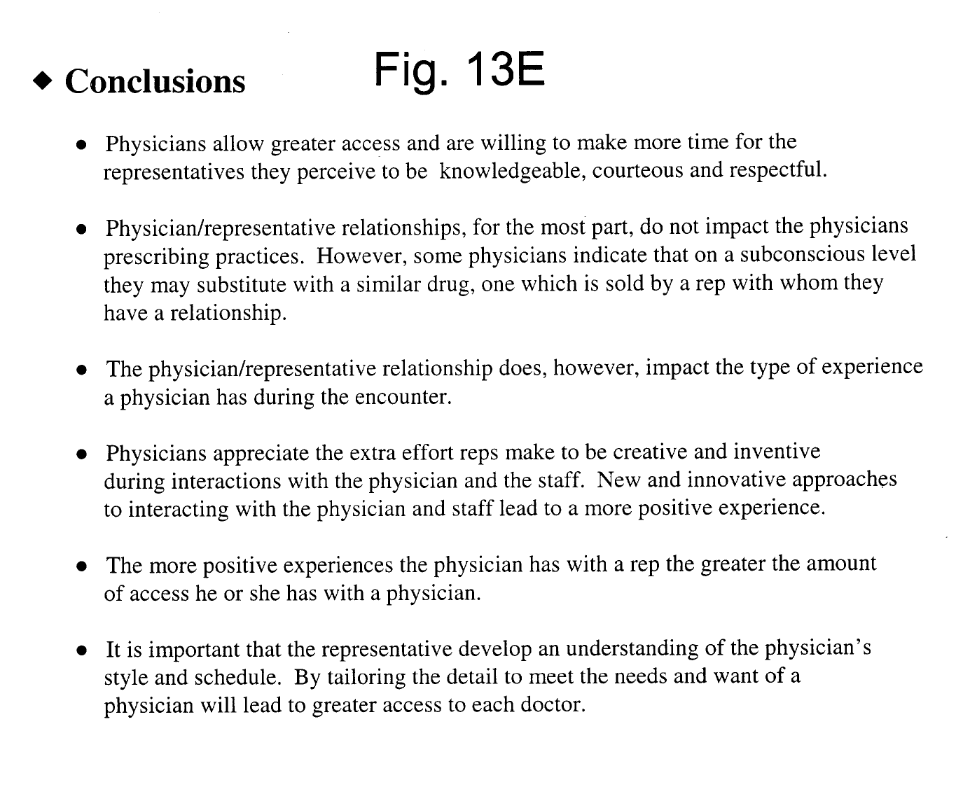

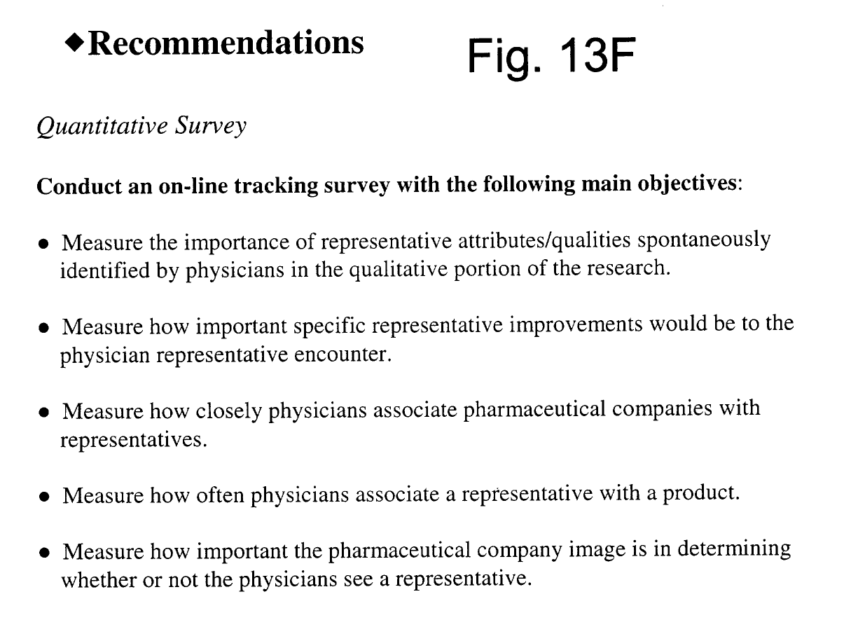

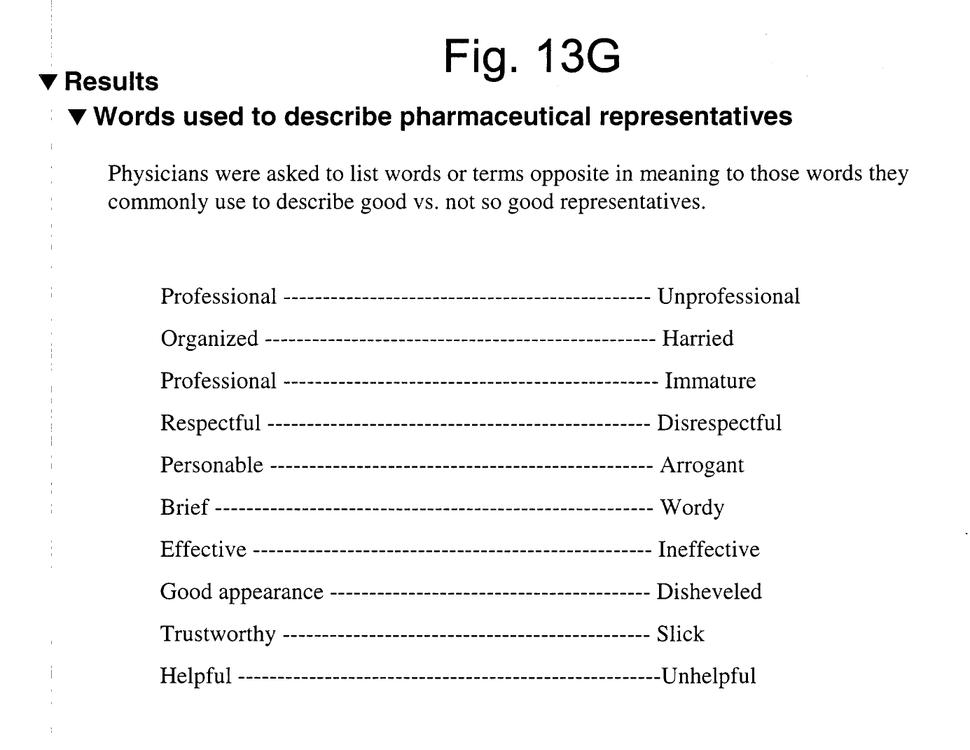

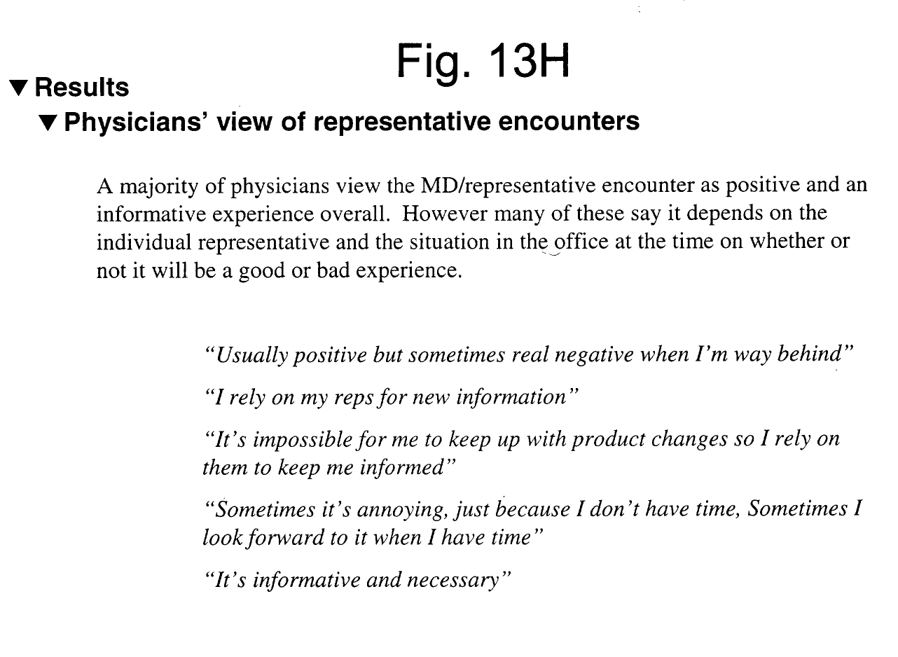

The studies of FIGS. 11 and 12 represent syndicated studies that can be provided to any pharmaceutical company having an interest in such a study, e.g., pharmaceutical companies whose drugs are the subject of the study. As mentioned earlier, custom or proprietary studies can also be conducted in accordance with this invention. To that end, reference should be made to FIGS. 13A-13H. These figures represent some of the slides of an output report of a custom primary research study conducted for an exemplary (anonymous) pharmaceutical company to assess the qualities of its sales representatives. The Output Report for this study is entitled “Qualitative Research Study-Pharmaceutical Representative Qualities.”

FIG. 13A is the first or title slide of the report. FIG. 13B is a slide introducing the objectives of the study, e.g., to identify key characteristics associated with ideal sales representatives. FIG. 13C is a slide which describes the field work and methodology of the study and other factors, e.g., the time period of the study, geographic extent of the study, etc. FIG. 13D is a slide which provides an executive summary of the results of the study. FIG. 13E is a slide setting out the conclusions of the Research Provider. FIG. 13F is a slide bearing recommendations of the Research Provider. FIG. 13G is a slide of further results of the study, e.g., words used to describe pharmaceutical representatives. FIG. 13H is another slide of further results of the study, namely, the physicians' view of representative encounters. As should be appreciated from the foregoing the subject invention enables one to conduct a primary market research study which can provide highly accurate results, since various attributes of the physicians to whom the study is directed are known. In this regard, the promotion activities to which the physicians who are candidates for the study are exposed are known, as are their treatment/prescribing activities, such information having been previously captured from them and stored. Thus, these physician promotion/treatment factors do not have to be surmised or inferred, as is the case of the prior art. By so doing this invention enables a primary market research study to be conducted which can be targeted to selected physicians based on a variety of known criteria to provide highly accurate and meaningful results.

Without further elaboration the foregoing will so fully illustrate our invention that others may, by applying current or future knowledge, adopt the same for use under various conditions of service.

We claim:

1. A method for collecting information for the pharmaceutical industry to evaluate the attitudes, beliefs and opinions of physicians regarding specific pharmaceuticals, said method comprising:
(A) establishing a single panel of a plurality of geographically diversified prescribing physicians;
(B) collecting promotional activity data from each of said physicians regarding the promotional activities of the sales representatives with respect to said physicians and to specific pharmaceuticals to determine the promotional exposure to said physicians;
(C) collecting treatment data from each of said physicians regarding the diagnosis and treatment of their patients with respect to said specific pharmaceuticals to determine the treatment patterns of said physicians;
(D) using said promotional activity data and said treatment data to establish the known history of promotional exposure to said physicians and the known patient treatment patterns of said physicians; and
(E) collecting attitude, belief and opinion data from at least selected ones of said physicians regarding their attitudes, beliefs and opinions with respect to said specific pharmaceuticals.

2. The method of claim 1 additionally comprising the step of:
(F) analyzing the attitude and opinion data regarding the attitudes, beliefs and opinions of said physicians based on their known history of promotional exposures and treatment patterns.

3. The method of claim 2 wherein said step of collecting said attitude, belief and opinion data is achieved by use of surveys administered through the Internet and/or by mail.

4. The method of claim 2 wherein said step of collecting attitude, belief and opinion data is achieved by use of in-depth interviews conducted in-person and/or over the telephone.

5. The method of claim 2 wherein said step of collecting attitude, belief and opinion data is achieved by use of focus groups conducted in-person and/or over the Internet.

6. The method of claim 2 wherein said step of collecting attitude, belief and opinion data is achieved by use of interactive voice response telephone surveys.

7. The method of claim 2 wherein said analyzing of the attitude, belief and opinion data comprises analyzing said data as a function of the nature and extent of sales representative promotional activities recorded by said physicians.

8. The method of claim 2 wherein said analyzing of the attitude, belief and opinion data comprises analyzing said data as a function of the promotional messages perceived and recorded by said physicians.

9. The method of claim 2 wherein said analyzing of the attitude, belief and opinion data comprises analyzing said data as a function of the extent to which patient treatment provided by said physicians varies.

10. The method of claim 2 wherein said analyzing of the attitude, belief and opinion data comprises analyzing said data as a function of the access of said sales representatives to said physicians.

11. The method of claim 2 wherein said analyzing of the attitude, belief and opinion data comprises analyzing said data as a function of the quantity of the encounters of said sales representatives to said physicians.

12. The method of claim 2 wherein said analyzing of the attitude, belief and opinion data comprises analyzing said data as a function of the quality of the encounters of said sales representatives to said physicians.

13. The method of claim 2 wherein said analyzing of the attitude, belief and opinion data comprises analyzing said data as a function of the impact of said sales representatives on the treatment decisions of said physicians.

14. The method of claim 2 additionally comprising evaluating changes in attitude, beliefs and opinions of said at least selected ones of said physicians by conducting attritional research on their attitudes, beliefs and opinions at some future point in time.

15. The method of claim 2 additionally comprising providing reports regarding the attitudes, beliefs and opinions of said physicians.

16. The method of claim 15 wherein said reports are in the form of perceptual maps and/or Point Vector Maps.

17. The method of claim 15 wherein said reports are produced by simple cross-tab generation.

18. The method of claim 15 wherein said reports are produced by multiple regression analysis and/or other multivariate techniques to assess stated versus derived importance.

19. The method of claim 15 wherein said reports are produced by verbatim analysis.

20. The method of claim 14 additionally comprising providing reports regarding the attitudes, beliefs and opinions of said physicians.

21. The method of claim 20 wherein said reports are in the form of perceptual maps and/or Point Vector Maps.

22. The method of claim 20 wherein said reports are produced by simple cross-tab generation.

23. The method of claim 20 wherein said reports are produced by multiple regression analysis and/or other multivariate techniques to assess stated versus derived importance.

24. The method of claim 20 wherein said reports are produced by verbatim analysis.

25. A system for collecting information for the pharmaceutical industry to evaluate the attitudes, beliefs and opinions of a single panel of a plurality of geographically diversified prescribing physicians regarding specific pharmaceuticals, said system comprising:
(A) means for collecting promotional activity data from each of said physicians regarding the promotional activities of the sales representatives with respect to said physicians and to specific pharmaceuticals to determine the promotional exposure to said physicians;
(C) means for collecting treatment data from each of said physicians regarding the diagnosis and treatment of their patients with respect to said specific pharmaceuticals to determine the treatment patterns of said physicians;
(D) means using said promotional activity data and said treatment data to establish the known history of promotional exposure to said physicians and known patient treatment patterns of said physicians; and
(E) means for collecting attitude, belief and opinion data from at least selected ones of said physicians regarding their attitudes, beliefs and opinions with respect to said specific pharmaceuticals.

26. The system of claim 25 wherein said means for collecting comprises electronic communication means.

27. The system of claim 26 wherein said electronic communication means makes use of the Internet.

28. The system of claim 25 additionally comprising a report including the results of said evaluation.

29. The system of claim 28 wherein the report includes perceptual maps.

30. A method for collecting information for the medical device industry to evaluate the attitudes, beliefs and opinions of physicians regarding specific medical products, said method comprising:
(A) establishing a single panel of a plurality of geographically diversified physicians;
(B) collecting promotional activity data from each of said physicians regarding the promotional activities of the sales representatives with respect to said physicians and to specific medical products to determine the promotional exposure to said physicians;
(C) collecting treatment data from each of said physicians regarding the diagnosis and treatment of their patients with respect to said specific medical products to determine the treatment patterns of said physicians;
(D) using said promotional activity data and said treatment data to establish the known history of promotional exposure to said physicians and the known patient treatment patterns of said physicians; and
(E) collecting attitude, belief and opinion data from at least selected ones of said physicians regarding their attitudes, beliefs and opinions with respect to said specific medical products.

31. The method of claim 30 additionally comprising the step of:
(F) analyzing the attitude and opinion data regarding the attitudes, beliefs and opinions of said physicians based on their known history of promotional exposures and treatment patterns.

32. The method of claim 31 wherein said step of collecting said attitude, belief and opinion data is achieved by use of surveys administered through the Internet and/or by mail.

33. The method of claim 31 wherein said step of collecting attitude, belief and opinion data is achieved by use of in-depth interviews conducted in-person and/or over the telephone.

34. The method of claim 31 wherein said step of collecting attitude, belief and opinion data is achieved by use of focus groups conducted in-person and/or over the Internet.

35. The method of claim 31 wherein said step of collecting attitude, belief and opinion data is achieved by use of interactive voice response telephone surveys.

36. A system for collecting information for the medical products industry to evaluate the attitudes, beliefs and opinions of a single panel of a plurality of geographically diversified physicians regarding specific medical devices, said system comprising:
(A) means for collecting promotional activity data from each of said physicians regarding the promotional activities of the sales representatives with respect to said physicians and to specific medical devices to determine the promotional exposure to said physicians;
(C) means for collecting treatment data from each of said physicians regarding the diagnosis and treatment of their patients with respect to said specific medical devices to determine the treatment patterns of said physicians;
(D) means using said promotional activity data and said treatment data to establish the known history of promotional exposure to said physicians and known patient treatment patterns of said physicians; and
(E) means for collecting attitude, belief and opinion data from at least selected ones of said physicians regarding their attitudes, beliefs and opinions with respect to said specific medical devices.

37. The system of claim 36 wherein said means for collecting comprises electronic communication means.

38. The system of claim 37 wherein said electronic communication means makes use of the Internet.

39. The system of claim 36 additionally comprising a report including the results of said evaluation.

40. The system of claim 39 wherein the report includes perceptual maps.
